(19) United States
(12) Patent Application Publication
(10) Pub. No.: US 2018/0373328 A1
(43) Pub. Date: Dec. 27, 2018

(54) PROGRAM EXECUTED BY A COMPUTER OPERABLE TO COMMUNICATE WITH HEAD MOUNT DISPLAY, INFORMATION PROCESSING APPARATUS FOR EXECUTING THE PROGRAM, AND METHOD EXECUTED BY THE COMPUTER OPERABLE TO COMMUNICATE WITH THE HEAD MOUNT DISPLAY

(71) Applicant: COLOPL, Inc., Tokyo (JP)

(72) Inventor: Kazuaki SAWAKI, Tokyo (JP)

(21) Appl. No.: 15/989,735

(22) Filed: May 25, 2018

(30) Foreign Application Priority Data
May 26, 2017 (JP) 2017-104925

(51) Int. Cl. G06F 3/01; G06T 19/00; G02B 27/00; G06Q 30/02

(52) U.S. Cl. CPC G06F 3/013; G06T 19/006; G02B 27/0093; G06T 2210/12; G06T 2210/61; G06T 2219/004; G06Q 30/0277

(57) ABSTRACT

A method includes defining a virtual space, wherein the virtual space comprises a first virtual viewpoint associated with a first viewpoint of a first user. The method includes detecting a first line of sight of the first user. The method includes identifying a first virtual line of sight from the first virtual viewpoint based on the first line of sight. The method includes identifying an eye gaze position of the first virtual line of sight. The method further includes defining a predetermined condition relating to an interest of the first user. The method includes detecting an operation or a motion of the first user. The method includes determining whether the operation or the motion satisfies the predetermined condition. The method includes storing the eye gaze position in a storage device in accordance with the operation or motion satisfying the predetermined condition when the operation or motion satisfies the predetermined condition.

### TECHNICAL FIELD

This disclosure relates to a technology for acquiring an interest of a user who is using a head-mounted device, and more particularly, to a technology for acquiring the interest of the user based on a line of sight of the user.

### BACKGROUND

In recent years, development of a technology for providing virtual reality by using a head-mounted device (HMD) has been actively conducted.

For example, in Patent Document 1, there is described a technology for acquiring a line of sight of a user wearing an HMD. In Non Patent Document 1, there is described a technology in which, in a shooting game in a virtual space, a target object is aimed at by using the line of sight of the user.

### PATENT DOCUMENT

[Patent Document 1] US 2016/0038069 A1

### NON-PATENT DOCUMENTS

[Non Patent Document 1] “Large Change in Experience with Single Line of Sight. VR Headset equipped with Eye Tracking System ‘FOVE’”, [online], [retrieved on Apr. 20, 2017], Internet <URL: http://www.gizmodo.jp/2016/09/tgs2016-vr-fove.html>

### SUMMARY

According to at least one embodiment of this disclosure, there is provided a method including defining a virtual space, the virtual space including a first virtual standpoint associated with a first standpoint of a first user, the first user being associated with a first head-mounted device (HMD). The method further includes detecting a first line of sight of the first user. The method further includes identifying a first virtual line of sight from the first virtual standpoint in the virtual space in accordance with the first line of sight. The method further includes identifying an eye gaze position of the first virtual line of sight in accordance with the first virtual line of sight. The method further includes defining a predetermined condition relating to an interest of the first user. The method further includes detecting an operation and/or a motion of the first user. The method further includes determining whether the operation and/or the motion satisfies the predetermined condition. The method further includes and storing the eye gaze position in a storage device in accordance with the operation and/or motion satisfying the predetermined condition, the eye gaze position including the eye gaze position identified when the operation and/or motion satisfies the predetermined condition.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of modules of the computer according to at least one embodiment of this disclosure.

FIG. 15 A diagram of processing for detecting a mouth from a facial image of the user according to at least one embodiment of this disclosure.

FIG. 16 A diagram of processing for detecting a shape of the mouth by a motion detection module according to at least one embodiment of this disclosure.

FIG. 17 A diagram of processing for detecting the shape of the mouth by the motion detection module according to at least one embodiment of this disclosure.

FIG. 18 A table of a face tracking data structure according to at least one embodiment of this disclosure.

FIG. 19 A diagram of a hardware configuration and a module configuration of the server according to at least one embodiment of this disclosure.

FIG. 20 A flowchart of processing in which the server communicates to/from computers to update user information according to at least one embodiment of this disclosure.

FIG. 21 A diagram of a field-of-view image visually recognizable by the user according to at least one embodiment of this disclosure.

FIG. 22 A diagram of the virtual space corresponding to the state of FIG. 21 according to at least one embodiment of this disclosure.

FIG. 23 A table of a data structure of viewpoint position information according to at least one embodiment of this disclosure.

FIG. 24A A diagram of facial feature points acquired when the user has a neutral facial expression according to at least one embodiment of this disclosure.

FIG. 24B A diagram of facial feature points acquired when the user is surprised according to at least one embodiment of this disclosure.

FIG. 25 A flowchart of processing for storing a viewpoint position in a storage according to at least one embodiment of this disclosure.

FIG. 26 A flowchart of processing for storing the viewpoint position and a type of an emotion in association with each other according to at least one embodiment of this disclosure.

FIG. 27 A diagram of a heat map based on viewpoint position information according to at least one embodiment of this disclosure.

FIG. 28 A flowchart of a series of processing steps until identification of a target at which the user is directing his or her line of sight to distribute an advertisement according to at least one embodiment of this disclosure.

FIG. 29 A table of a data structure of a panorama image DB according to at least one embodiment of this disclosure.

FIG. 30 A table of a data structure of a table according to at least one embodiment of this disclosure.

FIG. 31 A table of a data structure of a table according to at least one embodiment of this disclosure.

FIG. 32 A diagram of processing for recommending a panorama image to the user according to at least one embodiment of this disclosure.

FIG. 33 A diagram of processing to be executed when the viewpoint position is not stored in the viewpoint position information according to at least one embodiment of this disclosure.

FIG. 34 A flowchart of processing for stopping the processing for storing the viewpoint position in the viewpoint position information according to at least one embodiment of this disclosure.

FIG. 35 A flowchart of processing of stopping the processing for storing the viewpoint position according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

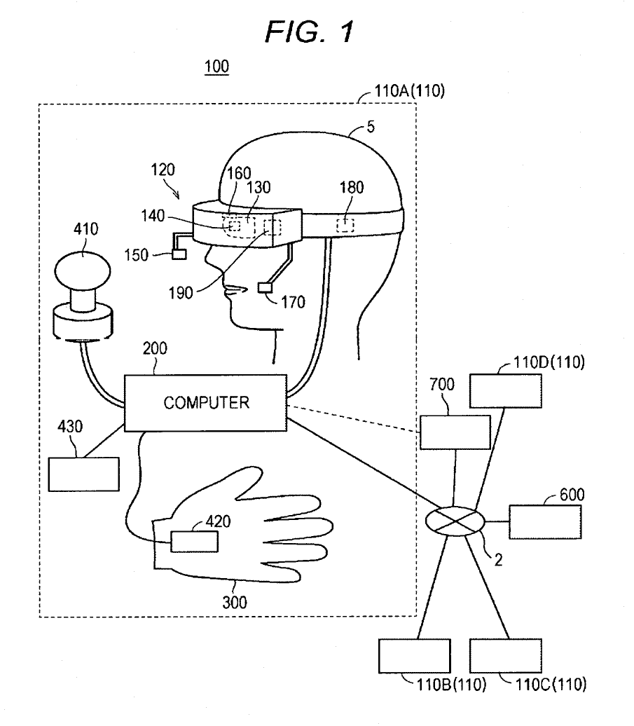

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

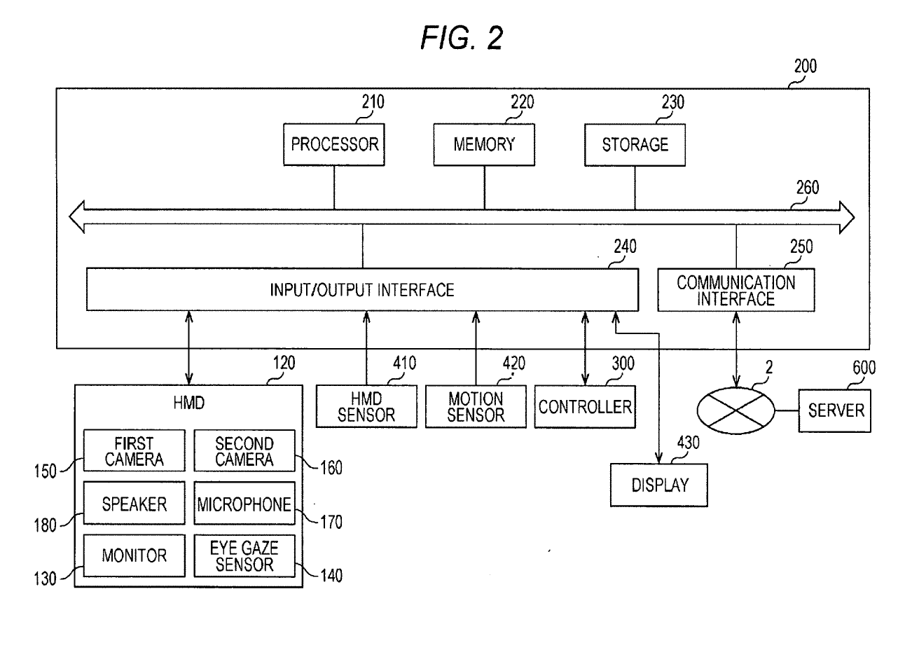

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

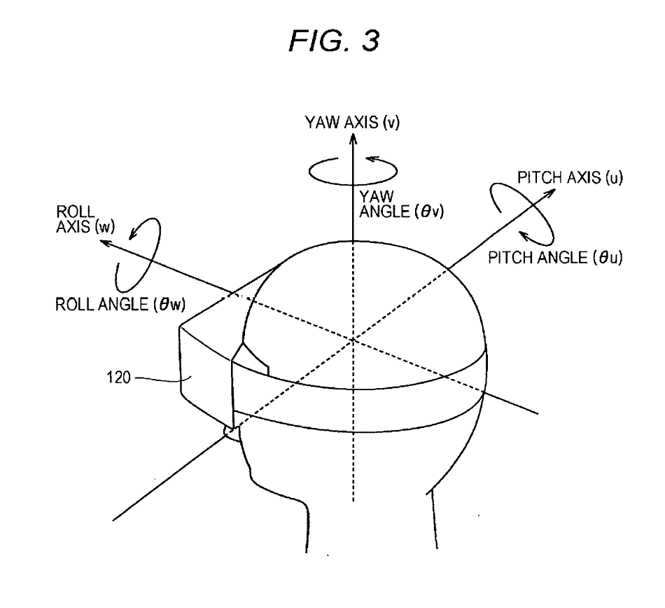

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

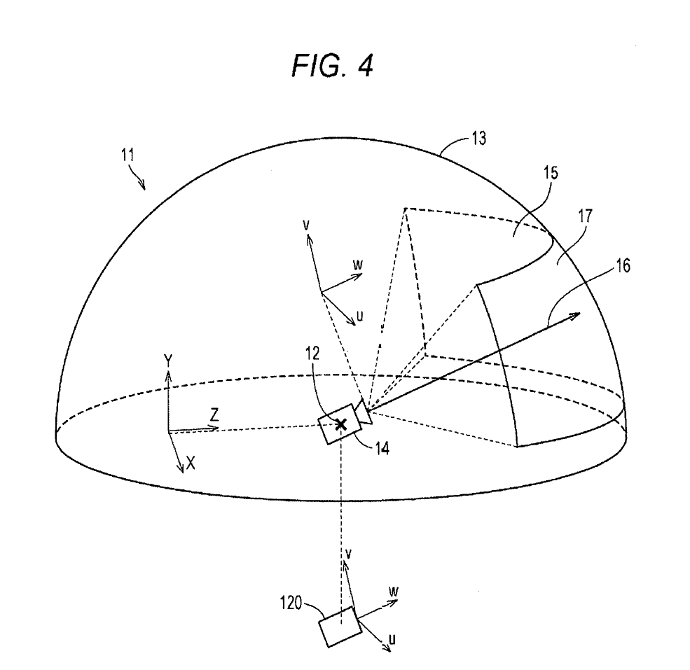

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

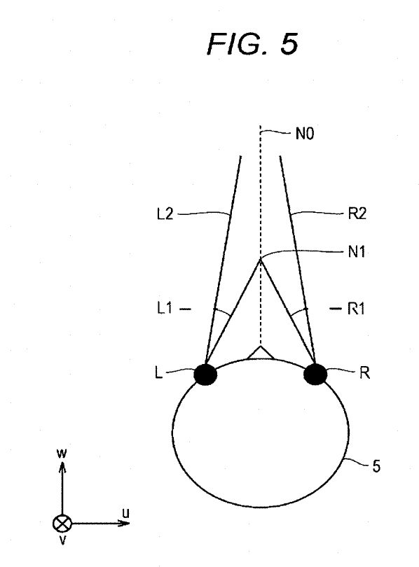

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

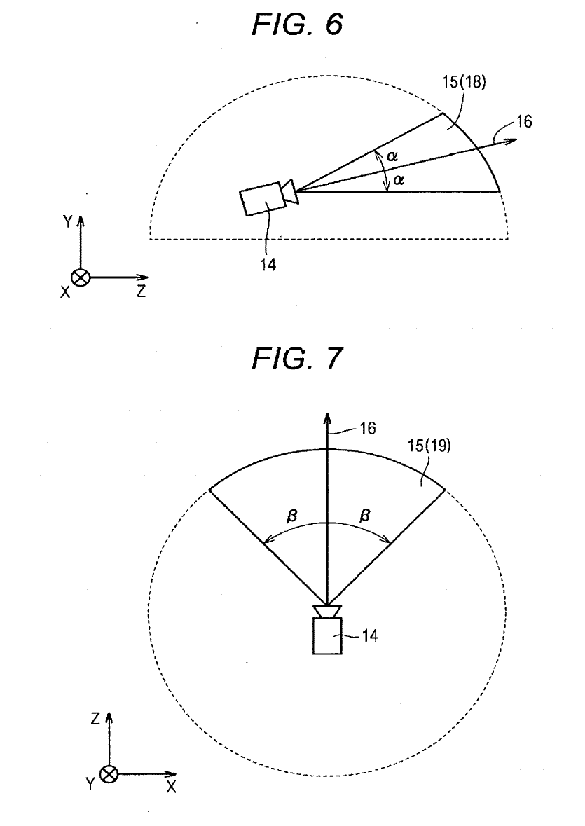

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

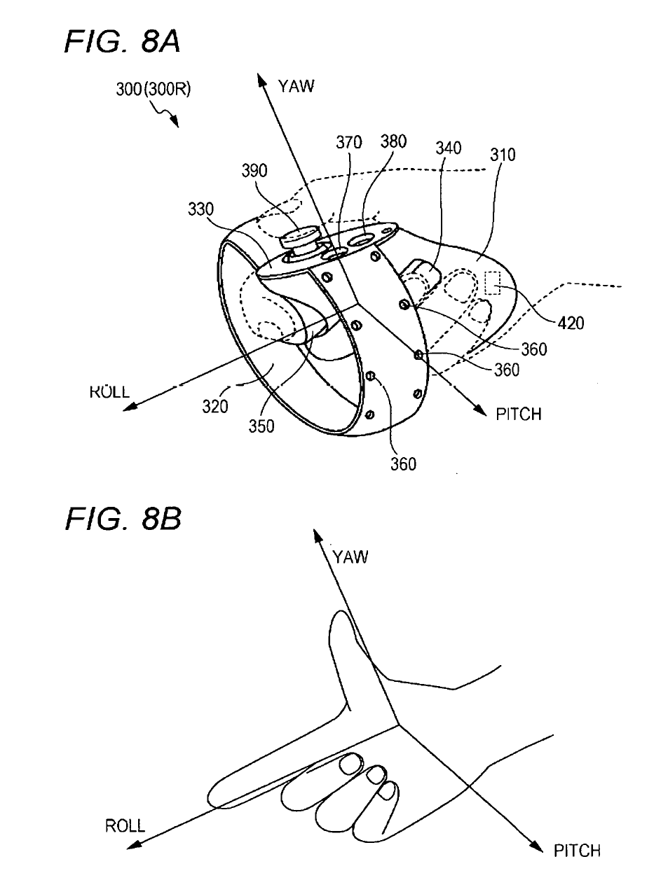

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

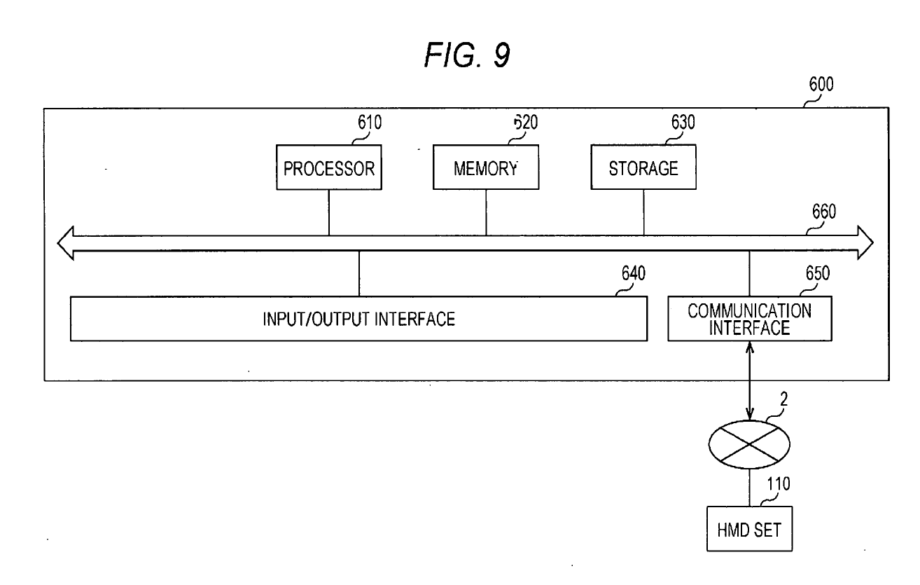

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

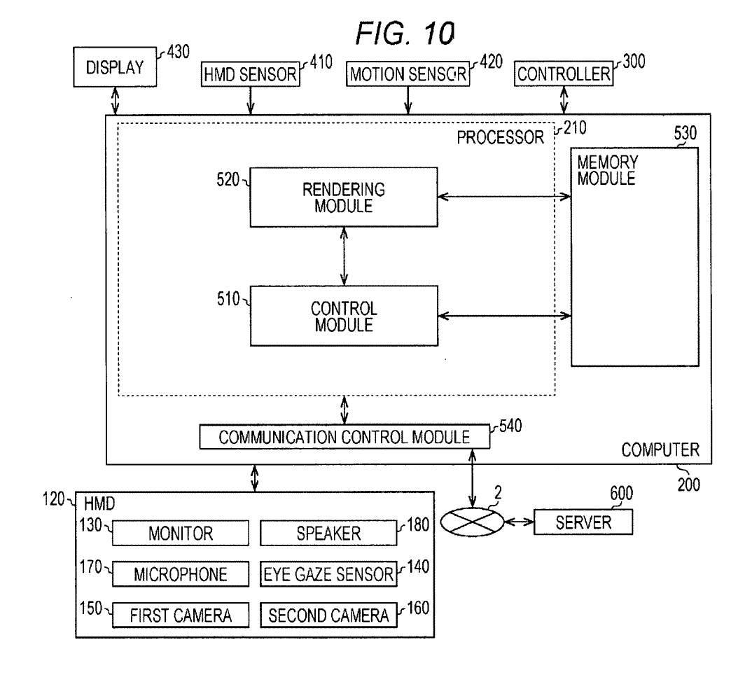

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

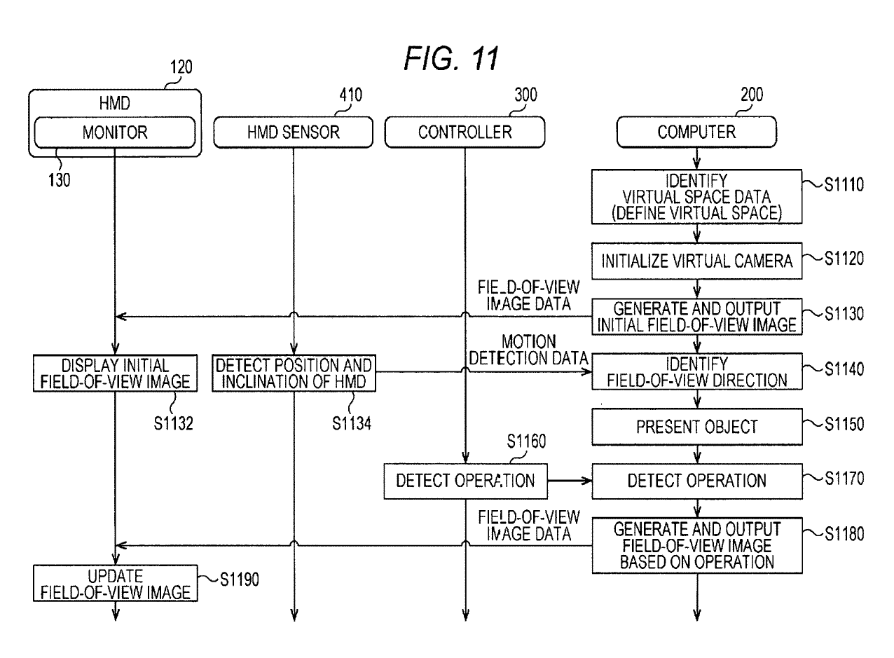

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

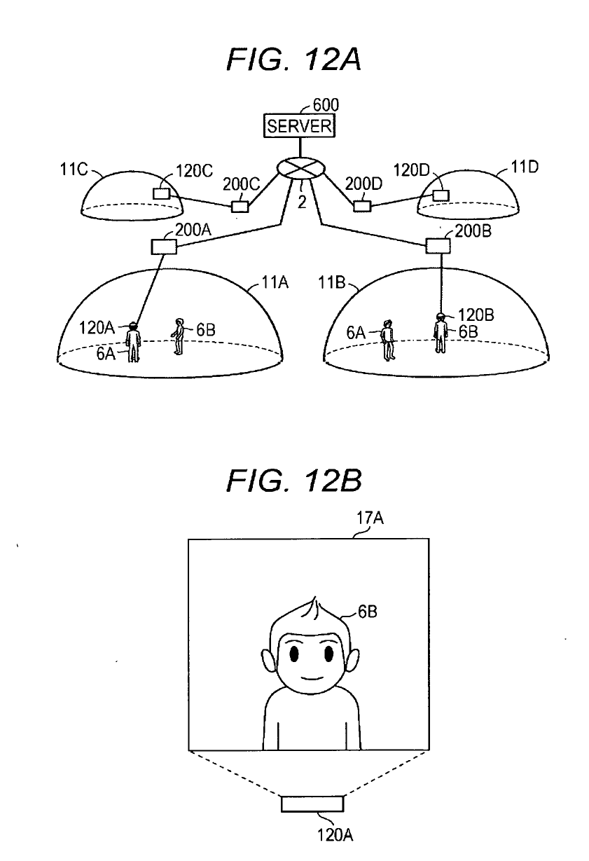

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

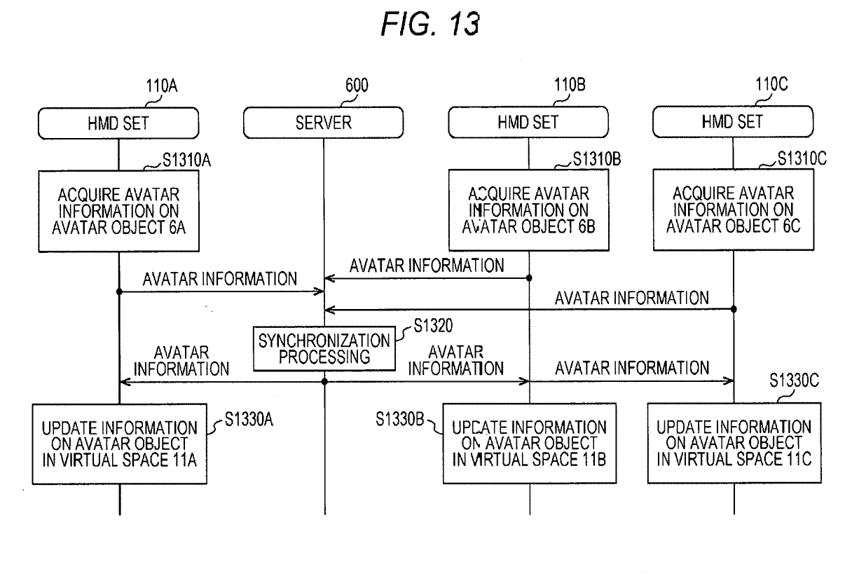

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

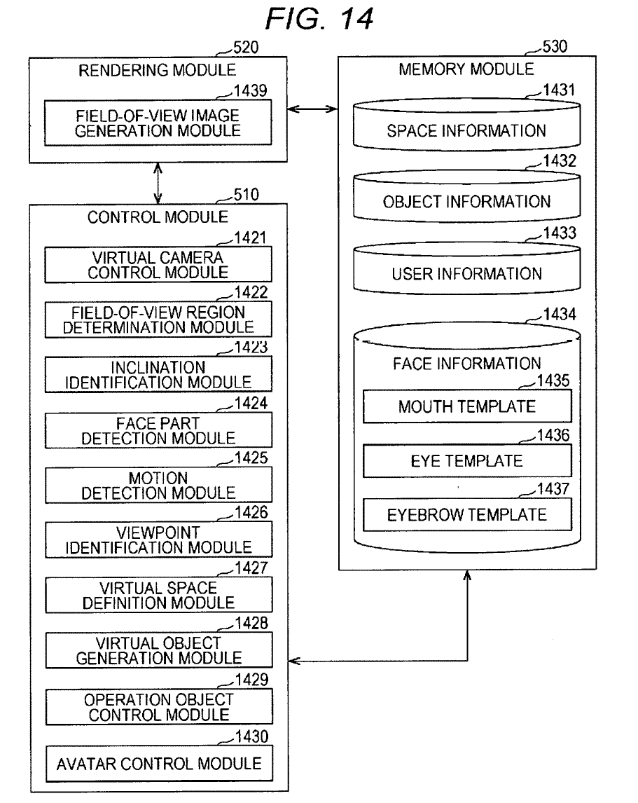

With reference to FIG. 14, a module configuration of the computer 200 are described. FIG. 14 is a block diagram of a configuration of modules of the computer 200 according to at least one embodiment of this disclosure.

In FIG. 14, the control module 510 includes a virtual camera control module 1421, a field-of-view region determination module 1422, an inclination identification module 1423, a face part detection module 1424, a motion detection module 1425, a viewpoint identification module 1426, a virtual space definition module 1427, a virtual object generation module 1428, an operation object control module 1429, and an avatar control module 1430. The rendering module 520 includes a field-of-view image generation module 1439. The memory module 530 stores space information 1431, object information 1432, user information 1433, and a face template 1434.

In at least one aspect, the control module 510 controls an image displayed on the monitor 130 of the HMD 120.

The virtual camera control module 1421 arranges the virtual camera 14 in the virtual space 11. The virtual camera control module 1421 controls a position of the virtual camera 14 in the virtual space 11 and the inclination (direction) of the virtual camera 14. The field-of-view region determination module 1422 defines the field-of-view region 15 in accordance with the inclination of the head of the user 5 wearing the HMD 120 and the position of the virtual camera 14. The field-of-view image generation module 1439 generates the field-of-view image 17 to be displayed on the monitor 130 based on the determined field-of-view region 15.

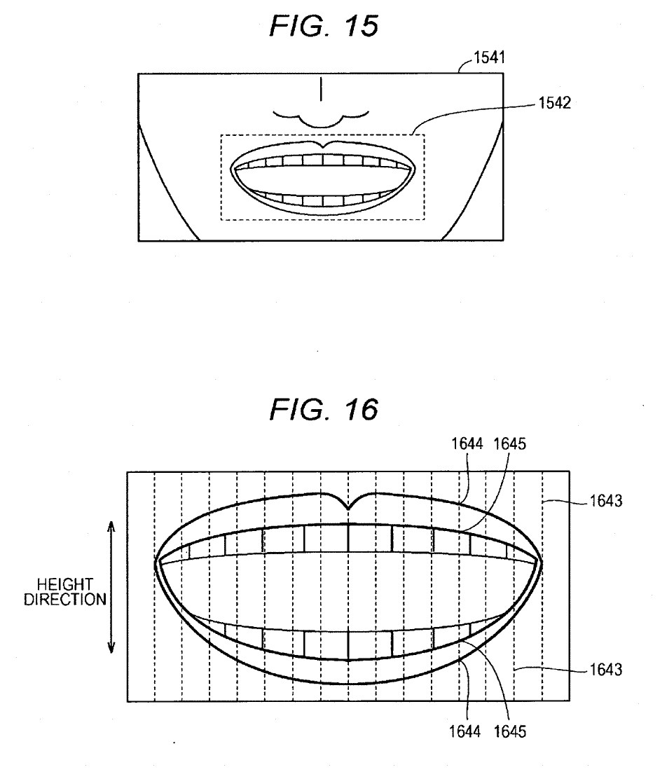

The inclination identification module 1423 identifies the inclination of the HMD 120 based on output of the HMD sensor 410. In at least one aspect, the inclination identification module 1423 identifies the inclination of the HMD 120 based on output of the sensor 190 functioning as a motion sensor. The face part detection module 1424 detects parts (e.g., mouth, eyes, and eyebrows) forming the face of the user 5 from a facial image of the user 5 generated by the first camera 150 and the second camera 160. The motion detection module 1425 detects a motion (shape) of each part detected by the face part detection module 1424. The details of control by the face part detection module 1424 and the motion detection module 1425 are described later with reference to FIG. 15 to FIG. 17.

The viewpoint identification module 1426 detects a line of sight of the user 5 in the virtual space 11 based on a signal from the eye gaze sensor 140. Next, the viewpoint identification module 1426 detects a point-of-view position (coordinate values in the XYZ coordinate system) at which the detected line of sight of the user 5 and the celestial sphere of the virtual space 11 intersect with each other. More specifically, the viewpoint identification module 1426 detects the point-of-view position based on the line of sight of the user 5 defined in the uvw coordinate system and the position and the inclination of the virtual camera 14. The viewpoint identification module 1426 transmits the detected point-of-view position to the server 600. In at least one aspect, the viewpoint identification module 1426 may be configured to transmit line-of-sight information representing the line of sight of the user 5 to the server 600. In such a case, the viewpoint identification module 1426 may calculate the point-of-view position based on the line-of-sight information received by the server 600.

The control module 510 controls the virtual space 11 provided to the user 5. The virtual space definition module 1427 generates virtual space data representing the virtual space 11, to thereby define the virtual space 11 in the HMD system 100.

The virtual object generation module 1428 generates objects to be arranged in the virtual space 11. The objects may include, for example, forests, mountains, other landscapes, and animals to be arranged in accordance with the progression of the story of the game.

The operation object control module 1429 arranges, in the virtual space 11, an operation object for receiving an operation of the user 5 in the virtual space 11. The user 5 operates the operation object to operate an object arranged in the virtual space 11, for example. In at least one aspect, the operation object includes, for example, a hand object corresponding to the hand of the user 5. In at least one aspect, the operation object control module 1429 moves the hand object in the virtual space 11 so that the hand object moves in association with a motion of the hand of the user 5 in the real space based on output of the motion sensor 420. In at least one aspect, the operation object corresponds to a hand part of an avatar object described later.

The avatar control module 1430 generates data for arranging an avatar object of the user 5 of another computer 200, which is connected via the network, in the virtual space 11. In at least one aspect, the avatar control module 1430 generates data for arranging an avatar object of the user 5 in the virtual space 11. In at least one aspect, the avatar control module 1430 generates an avatar object simulating the user 5 based on an image including the user 5. In at least one aspect, the avatar control module 1430 generates data for arranging in the virtual space 11 an avatar object that is selected by the user 5 from among a plurality of types of avatar objects (e.g., objects simulating animals or objects of deformed humans).

The avatar control module 1430 translates the motion of the HMD 120 detected by the HMD sensor 410 in the avatar object. For example, the avatar control module 1430 detects that the HMD 120 has been inclined, and generates data for arranging the avatar object in an inclined manner. In at least one aspect, the avatar control module 1430 translates a motion of the controller 300 in an avatar object. In this case, the controller 300 includes, for example, a motion sensor, an acceleration sensor, or a plurality of light emitting elements (e.g., infrared LEDs) for detecting a motion of the controller 300. The avatar control module 1430 translates motions of face parts detected by the motion detection module 1425 in the face of an avatar object arranged in the virtual space 11.

When one object arranged in the virtual space 11 collides with another object in the virtual space 11, the control module 510 detects the collision. The control module 510 can detect, for example, a timing at which an object and another object have touched with each other, and perform predetermined processing in response to the detected timing. The control module 510 can also detect a timing at which an object and another object, which have been in contact with each other, have moved away from each other, and perform predetermined processing in response to the detected timing. The control module 510 can detect a state in which an object and another object are in contact with each other. Specifically, when an operation object touches another object, the operation object control module 1429 detects the fact that the operation object has touched the other object, and performs predetermined processing.

The space information 1431 stores one or more templates that are defined to provide the virtual space 11.

The object information 1432 stores a plurality of panorama images 13 forming the virtual space 11 and data for arranging objects in the virtual space 11. The panorama image 13 may contain a still image and a moving image. The panorama image 13 may contain an image in a non-real space and an image in the real space (e.g., computer graphics).

The user information 1433 stores a user ID for identifying the user 5. The user ID may be, for example, an internet protocol (IP) address or a media access control (MAC) address set to the computer 200 used by the user. In at least one aspect, the user ID is set by the user. The user information 1433 contains, for example, a program for causing the computer 200 to function as the control device of the HMD system 100.

The face template 1434 stores templates that are stored in advance for the face part detection module 1424 to detect face parts of the user 5. In at least one embodiment, the face template 1434 stores a mouth template 1435, an eye template 1436, and an eyebrow template 1437. Each template may be an image corresponding to a part forming the face. For example, the mouth template 1435 may be an image of a mouth. Each template may include a plurality of images.

[Face Tracking]

A specific example of detecting a facial expression (motion of face) of the user is now described with reference to FIG. 15 to FIG. 17. In FIG. 15 to FIG. 17, a specific example of detecting a motion of the mouth of the user 5 is described as at least one example. The detection method described with reference to FIG. 15 to FIG. 17 is not limited to a motion of the mouth of the user, and may be applied to detection of motions of other parts (e.g., eyes, eyebrows, nose, and cheeks) forming the face of the user 5.

FIG. 15 is a diagram of control for detecting a mouth from a facial image 1541 of the user according to at least one embodiment of this disclosure. The facial image 1541 generated by the first camera 150 includes the nose and mouth of the user 5.

The face part detection module 1424 identifies a mouth region 1542 from the facial image 1541 by pattern matching using the mouth template 1435 stored in the face template 1434. In at least one aspect, the face part detection module 1424 sets a rectangular comparison region in the facial image 1541, and calculates a similarity degree between an image of the comparison region and an image of the mouth template 1435 while changing the size, position, and angle of this comparison region. The face part detection module 1424 may identify, as the mouth region 1542, a comparison region for which a similarity degree larger than a threshold determined in advance is calculated.

The face part detection module 1424 may further determine whether the comparison region corresponds to the mouth region based on a relative relationship between the position of the comparison region for which the calculated similarity degree is larger than the threshold and positions of other face parts (e.g., eyes and nose).

The motion detection module 1425 detects a more detailed shape of the mouth from the mouth region 1542 detected by the face part detection module 1424.

FIG. 16 is a diagram a portion of processing for detecting the shape of the mouth by the motion detection module 1425 according to at least one embodiment of this disclosure. Referring to FIG. 16, the motion detection module 1425 sets a contour detection line 1643 for detecting the shape of the mouth (contour of lips) contained in the mouth region 1542. A plurality of contour detection lines 1643 are set at predetermined intervals in a direction orthogonal to a height direction of the face.

The motion detection module 1425 may detect a change in brightness value of the mouth region 1542 along each of the plurality of contour detection lines 1643, and identify a position at which the change in brightness value is abrupt as a contour point. More specifically, the motion detection module 1425 may identify, as the contour point, a pixel for which a brightness difference (namely, change in brightness value) between the pixel and an adjacent pixel is equal to or more than a threshold value determined in advance. The brightness value of a pixel is obtained by, for example, integrating RBG values of the pixel with predetermined weighting.

The motion detection module 1425 identifies two types of contour points from the image corresponding to the mouth region 1542. The motion detection module 1425 identifies a contour point 1644 corresponding to a contour of the outer side of the mouth (lips) and a contour point 1645 corresponding to a contour of the inner side of the mouth (lips). In at least one aspect, when three or more contour points are detected on one contour detection line 1643, the motion detection module 1425 identifies contour points on both ends of the contour detection line 1643 as the outer contour points 1644. In this case, the motion detection module 1425 may identify contour points other than the outer contour points 1644 as the inner contour points 1645. When two or less contour points are detected on one contour detection line 1643, the motion detection module 1425 may identify the detected contour points as the outer contour points 1644.

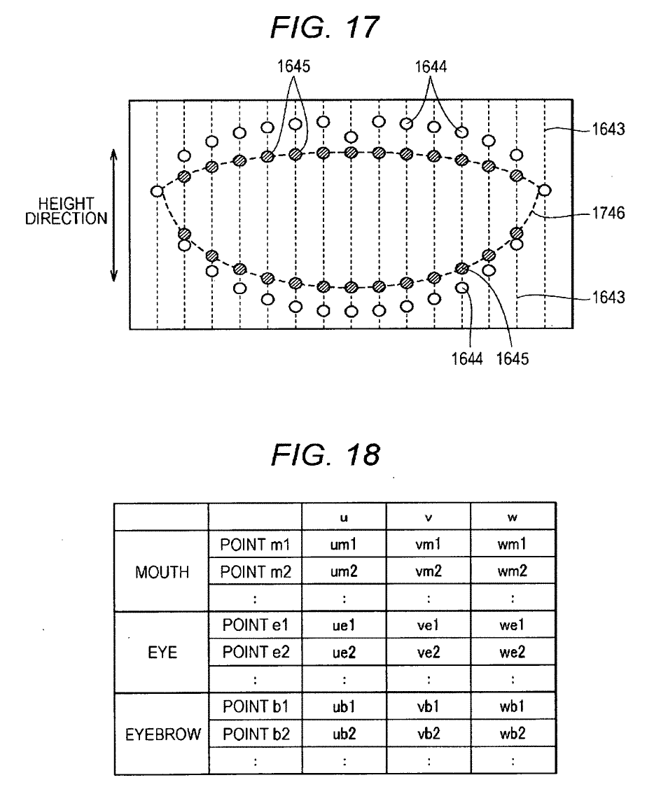

FIG. 17 is a diagram of a portion of processing for detecting the shape of the mouth by the motion detection module 1425 according to at least one embodiment of this disclosure. In FIG. 17, the outer contour points 1644 and the inner contour points 1645 are indicated by white circles and hatched circles, respectively.

The motion detection module 1425 interpolates points between the inner contour points 1645 to identify a mouth shape 1746. In at least one aspect, the motion detection module 1425 identifies the mouth shape 1746 using a nonlinear interpolation method, for example, spline interpolation. In at least one aspect, the motion detection module 1425 identifies the mouth shape 1746 by interpolating points between the outer contour points 1644. In at least one aspect, the motion detection module 1425 may identify the mouth shape 1746 by removing contour points that greatly deviate from an assumed mouth shape (predetermined shape that may be formed by upper lip and lower lip of person) and using the contour points that remain. In this manner, the motion detection module 1425 may identify a motion (shape) of the mouth of the user. The method of detecting the mouth shape 1746 is not limited to the above-mentioned method, and the motion detection module 1425 may detect the mouth shape 1746 with another technique. The motion detection module 1425 may detect motions of the eyes and eyebrows of the user in the same manner. The motion detection module 1425 is may be configured to be capable of detecting the shape of parts such as the cheeks and the nose.

FIG. 18 is a table of a face tracking data structure according to at least one embodiment of this disclosure. The motion detection module 1425 generates face tracking data representing the facial expression of the users. The face tracking data represents position coordinates in the uvw visual field coordinate system of the feature points forming the shape of each part to be detected. For example, points m1, m2 . . . shown in FIG. 18 correspond to the outer contour points 1644 forming the mouth shape 1746. In at least one aspect, the face tracking data is coordinate values in the uvw visual field coordinate system with the position of the first camera 150 as a reference (origin). In at least one aspect, the face tracking data is coordinate values in a coordinate system with feature points determined in advance for each part set as a reference (origin). As an example, the points m1, m2 . . . are coordinate values in a coordinate system with any one of the feature points corresponding to the corner of the mouth from among the outer contour points 1644 as the origin.

The computer 200 transmits the generated face tracking data to the server 600. The server 600 transfers this data to another computer 200 that communicates to/from the computer 200. The other computer 200 translates the received face tracking data in the avatar object corresponding to the user of the receiving computer 200.

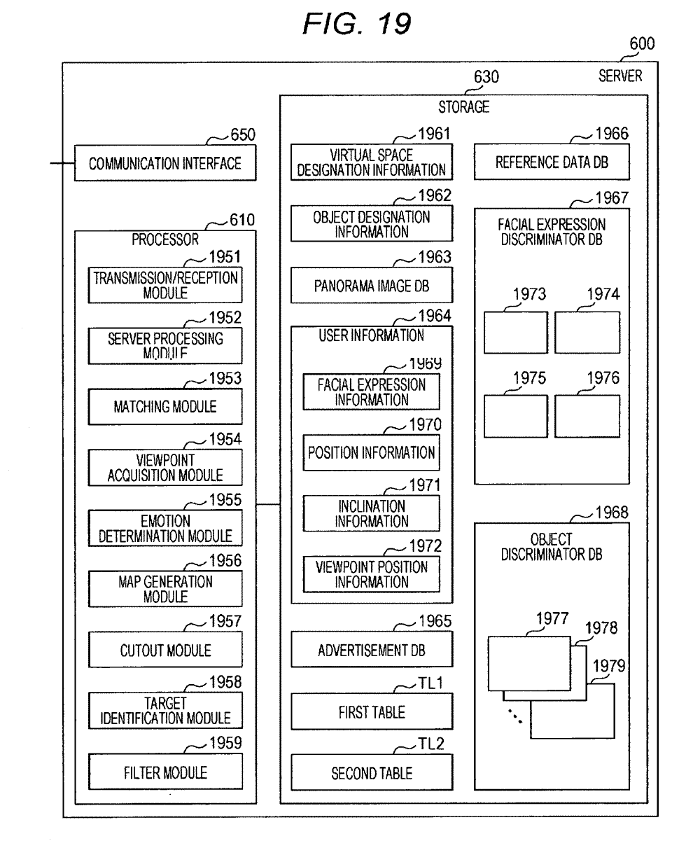

In FIG. 12B, the computer 200A receives face tracking data representing the facial expression of the user 5B from the computer 200B. The computer 200A translates the received data in the avatar object 6B. As at least one example, of the vertices of the polygons forming the avatar object 6B, the vertices corresponding to the face tracking data are set. The computer 200A moves the positions of the corresponding vertices based on the face tracking data, to thereby translate the facial expression of the user 5B in the avatar object 6B. As a result, the user 5A can recognize the facial expression of the user 5B via the avatar object 6B.

[Control Structure of Server 600] FIG. 19 is a diagram of a hardware configuration and a module configuration of the server 600 according to at least one embodiment of this disclosure. In at least one embodiment, the server 600 includes, as primary components, the communication interface 650, the processor 610, and the storage 630.

The communication interface 650 functions as a communication module for wireless communication, which is configured to perform, for example, modulation/demodulation processing for transmitting/receiving signals to/from an external communication device, for example, the computer 200. The communication interface 650 is implemented by, for example, a tuner or a high frequency circuit.

The processor 610 controls operation of the server 600. The processor 610 executes various control programs stored in the storage 630 to function as a transmission/reception module 1951, a server processing module 1952, a matching module 1953, a viewpoint acquisition module 1954, an emotion determination module 1955, a map generation module 1956, a cutout module 1957, a target identification module 1958, and a filter module 1959.

The transmission/reception module 1951 transmits/receives various kinds of information to/from each computer 200. For example, the transmission/reception module 1951 transmits to each computer 200 a request for arranging objects in the virtual space 11, a request for deleting objects from the virtual space 11, a request for moving objects, a sound by the user, or information for defining the virtual space 11.

The server processing module 1952 updates user information 1964 described later based on the information received from the computer 200.

The matching module 1953 performs a series of processing steps for associating a plurality of users with one another. For example, when an input operation for the plurality of users to share the same virtual space 11 is performed, the matching module 1953 performs, for example, processing of associating respective user IDs of those plurality of users belonging to the virtual space 11 with one another.

The viewpoint acquisition module 1954 acquires the viewpoint position of the user 5 in the virtual space 11 (XYZ coordinate system) based on the line-of-sight information received from the computer 200. When the viewpoint identification module 1426 of the computer 200 is capable of identifying the viewpoint location and transmitting the identified information to the server 600, it is not always required for the processor 610 to function as the viewpoint acquisition module 1954.

The emotion determination module 1955 determines the emotion of the user 5 based on the face tracking data received from the computer 200. The map generation module 1956 generates a map based on the viewpoint position of the user 5.

The cutout module 1957 cuts out a peripheral image of the viewpoint position of the user 5 in the panorama image 13 forming the virtual space 11. The target identification module 1958 identifies the content included in the peripheral image cut out by the cutout module 1957 (object at which line of sight of user is directed). The filter module 1959 determines whether to store the viewpoint position of the user 5 in the storage 630.

The storage 630 stores virtual space designation information 1961, object designation information 1962, a panorama image DB 1963, user information 1964, an advertisement DB 1965, a first table TL1, a second table TL2, a reference data DB 1966, a facial expression discriminator DB 1967, and an object discriminator DB 1968.

The virtual space designation information 1961 is information to be used by the virtual space definition module 1427 of the computer 200 to define the virtual space 11. For example, the virtual space designation information 1961 includes information for designating the size or shape of the virtual space 11.

The object designation information 1962 designates an object to be arranged (generated) in the virtual space 11 by the virtual object generation module 1428 of the computer 200. The panorama image DB 1963 stores a plurality of panorama images 13 to be distributed to the computer 200.

The user information 1964 includes the user ID received from each computer 200. In other words, the user information 1964 includes information for identifying each of a plurality of users.

The user information 1964 further includes facial expression information 1969, position information 1970, inclination information 1971, and viewpoint position information 1972. The facial expression information 1969 is face tracking data for each user. As an example, facial expression information 1969 is data in which a user ID and face tracking data are associated with each other.

The position information 1970 is data in which the user ID and the standpoint (position of virtual camera 14) of the user are associated with each other. The inclination information 1971 is data in which the user ID and the inclination of the virtual camera 14 (HMD 120) are associated with each other. The viewpoint position information 1972 is data in which the user ID, a panorama image ID, and the viewpoint position are associated with each other. Details of the viewpoint position information 1972 are described later. The user information 1964 is updated at any time by the server processing module 1952 based on information input from each computer 200.

The advertisement DB 1965 stores a plurality of advertisements for distribution to the computer 200. The first table TL1 stores each of the plurality of advertisements and a target to be identified by the target identification module 1958 in association with each other. The second table TL2 stores the target to be identified by the target identification module 1958 and the type of the panorama image 13 in association with each other. Details of the first table TL1 and the second table TL2 are described later.

The reference data DB 1966 stores the reference data to be used for comparison with the face tracking data and the user ID in association with each other. The facial expression discriminator DB 1967 includes a facial expression discriminator for each type of facial expression. As an example, the facial expression discriminator DB 1967 includes four types of facial expression discriminators 1973 to 1976. The facial expression discriminator 1973 functions as a program for identifying a laughing facial expression. The facial expression discriminator 1974 functions as a program for identifying an angry facial expression. The facial expression discriminator 1975 functions as a program for identifying surprised facial expressions. The facial expression discriminator 1976 functions as a program for identifying a sad facial expression. For example, the facial expression discriminator 1973 learns weighting coefficients using the face tracking data of a plurality of laughing people as training data.

The object discriminator DB 1968 contains an object discriminator for each type of object. In FIG. 19, object discriminators 1477, 1478, 1479, . . . are included in the object discriminator DB 1968. For example, the object discriminator 1477 functions as a program for identifying a cat.

[User Information Update Processing]

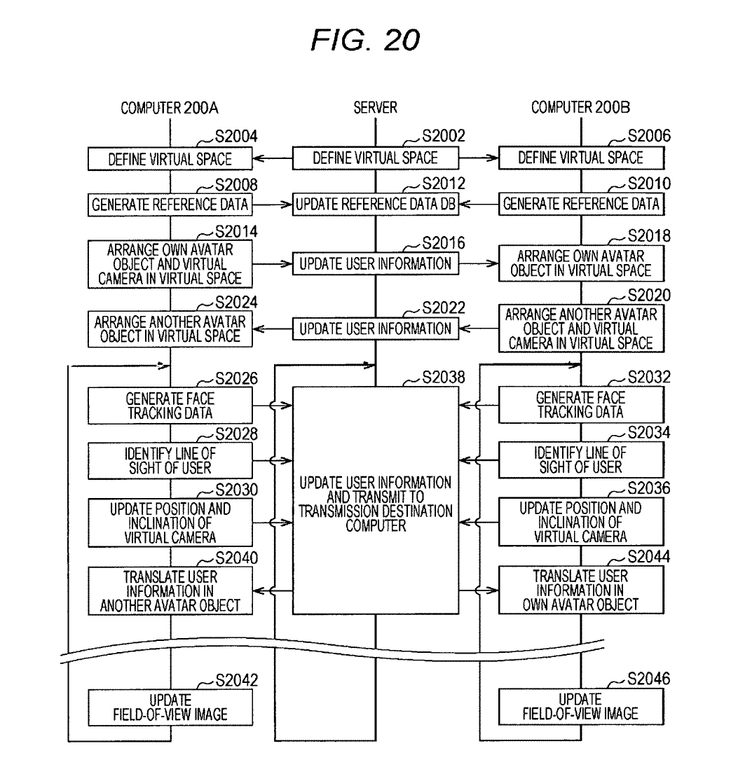

FIG. 20 is a flowchart of processing in which the server 600 communicates to/from the computers 200A and 200B to update the user information 1964 according to at least one embodiment of this disclosure. The processing in FIG. 20 may be implemented by the processor 210 of the computer 200 executing a control program stored in the memory 220 or the storage 230 and the processor 610 of the server 600 executing a control program stored in the storage 630.

In Step S2002, the processor 610 of the server 600 defines a virtual space based on information (e.g., information designating any one of a plurality of panorama images 13) input from the computers 200A and 200B. The processor 610 serves as the transmission/reception module 1951 to transmit virtual space designation information 1961 corresponding to the defined virtual space to the computers 200A and 200B. At this time, each computer 200 transmits the user ID to the server 600 together with the virtual space designation information 1961. The processor 610 may further serve as the matching module 1953 to associate those user IDs with each other, assuming that the users 5A and 5B share the same virtual space.

In Step S2004, the processor 210A of the computer 200A serves as a virtual space definition module 1427A to define the virtual space 11A. More specifically, the processor 210A constructs the virtual space 11A by using the panorama image 13A based on the received virtual space designation information 1961. In Step S2006, the processor 210B of the computer 200B defines the virtual space 11B in the same manner as the processor 210A.

In Step S2008, the processor 210A photographs the face of the user 5A by the first camera 150A and the second camera 160A. At this time, the processor 210A displays on the monitor 130A a message prompting the user to be photographed with a neutral facial expression. The processor 210A generates face tracking data based on the acquired image. The face tracking generated at this time functions as reference data. The processor 210A transmits the generated reference data to the server 600. In Step S2010, the processor 210B similarly generates reference data and transmits the reference data to the server 600. When transmitting some kind of data to the server 600, the processors 210A and 10B also transmit the user ID.

In Step S2012, the server 600 updates the reference data DB 1966 based on the reference data received from each computer 200.

In Step S2014, the processor 210A serves as the avatar control module 1430A to arrange the avatar object 6A (denoted by “own avatar object” in FIG. 20) of the user 5A himself or herself in the virtual space 11A. The processor 210A further arranges the virtual camera 14A at the position of the avatar object 6A (e.g., eye position). The processor 210A transmits position information on the avatar object 6A (i.e., standpoint information in virtual space 11A of user 5A) and modeling data to the server 600. When the avatar object 6A is an avatar selected from types determined in advance, the processor 210A may transmit information identifying that avatar type to the server 600.

In Step S2016, the processor 610 updates the position information 1970 corresponding to (the user ID of) the user 5A based on the received position information on the avatar object 6A. The processor 610 also transmits information received from the computer 200A to the computer 200B communicating to/from the computer 200A.

In Step S2018, the processor 210B serves as the avatar control module 1430B to arrange the avatar object 6A in the virtual space 11B based on the received information.

In Step S2020 to Step S2024, the avatar object 6B (denoted as “another avatar object” in FIG. 20) is generated in the virtual spaces 11A and 11B and the position information 1970 corresponding to the user 5B is updated in the same manner as in the Step S2014 to Step S2018.

In Step S2026, the processor 210A photographs the face of the user 5A with the first camera 150A and the second camera 160A, and generates a facial image including depth information. The processor 210A serves as the face part detection module 1424A and the motion detection module 1425A to generate face tracking data based on the facial image, and transmits the generated face tracking data to the server 600.

In Step S2028, the processor 210A serves as the viewpoint identification module 1426A to identify the viewpoint position of the user 5A in the virtual space 11A, and transmits the identified viewpoint position to the server 600.

In Step S2030, the processor 210A updates the position and inclination of the virtual camera 14A based on output of the HMD sensor 410 and/or output of the controller 300. The processor 210A transmits information indicating the updated position and inclination of the virtual camera 14A to the server 600.

In Step S2032 to Step S2036, the processor 210B transmits face tracking data, the viewpoint position of the user 5B in the virtual space 11B, and information indicating the position and inclination of the virtual camera 14B to the server 600 in the same manner as the processing in Step S2026 to Step S2030.

In Step S2038, the processor 610 updates the user information 1964 based on various information received from the computers 200A and 200B. In at least one aspect, the processor 610 may store in the viewpoint position information 1972, of the viewpoint positions received from each computer 200, only a viewpoint position that satisfies a condition determined in advance regarding the operation or motion of the user 5. Details of this processing, according to at least one embodiment, are described later.

The processor 610 also transmits the information received from the computer 200A to the computer 200B, and transmits the information received from the computer 200B to the computer 200A.

In Step S2040, the processor 210A translates the information received from the server 600 in the avatar object 6B arranged in the virtual space 11A. In Step S2042, the processor 210A outputs the field-of-view image photographed by the virtual camera 14A to the monitor 130A. As a result, the user 5A can visually recognize the avatar object 6B in which the motion and facial expression of the user 5B have been translated. Then, the processor 210A executes the processing of Step S2026 again.

In Step S2044 to Step S2046, the processor 210B executes the same processing as in the processing of Step S2040 to Step S2042. Then, the processor 210B executes the processing of Step S2032 again.

In at least one embodiment, the processing of Step S2026 to Step S2046 is executed repeatedly at an interval of 1/60 seconds or 1/30 seconds.

In at least one aspect, the repeatedly executed processing described above may include processing for transmitting sound uttered by the user 5 to the another computer 200, and processing for promoting communication among users in another virtual space 11.

[Processing for Storing Viewpoint Position in Memory]

The user 5 may evaluate the panorama image 13 forming the virtual space 11. When the user 5 performs an evaluation on the panorama image 13, the distributor of the panorama image 13 may not be able to grasp what the user 5 expressed interest in. The reason for this is that the panorama image 13 is developed in all directions in 360-degrees, and hence the distributor is not able to grasp which portion of the panorama image 13 the user 5 was looking at when the user performed his or her evaluation. Processing capable of helping to solve such a problem is now described.

(Storage Processing Based on User Operation)

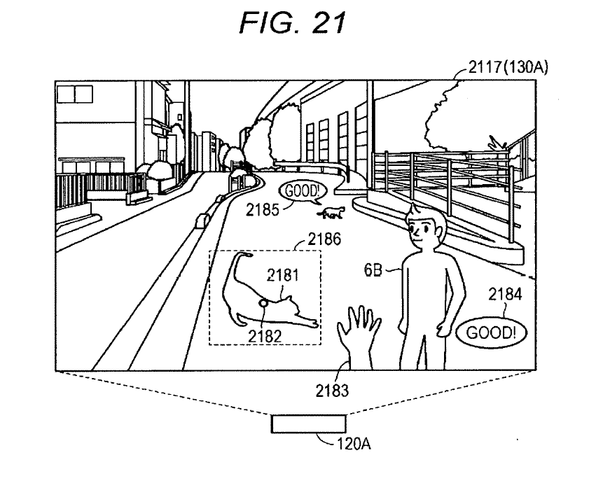

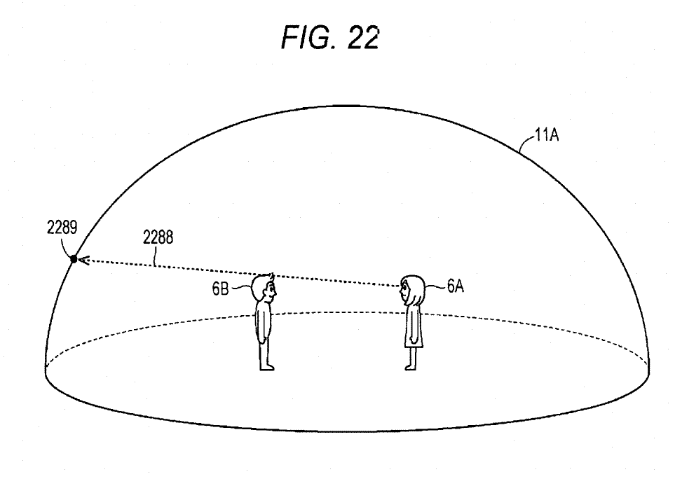

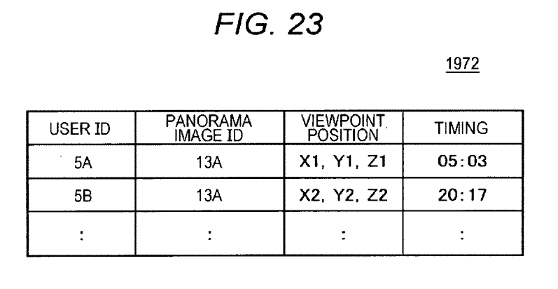

First, with reference to FIG. 21 and FIG. 22, processing for storing the viewpoint position of the user 5 in the memory based on a user operation is described. FIG. 21 is a diagram of a field-of-view image 2117 visually recognizable by the user 5A according to at least one embodiment of this disclosure. FIG. 22 is a diagram of the virtual space 11A corresponding to the state of FIG. 21 according to at least one embodiment of this disclosure.

In at least one aspect, a panorama image 13 representing a city scene in the real space is developed in the virtual space 11A. The field-of-view image 2117 is an image of the portion of the panorama image 13 corresponding to the field-of-view region 15. The field-of-view image 2117 includes a cat 2181, which is a portion of the panorama image 13. The field-of-view image 2117 further includes an avatar object 6B, a viewpoint object 2182, an operation object 2183, a UI object 2184, and an evaluation object 2185.

The viewpoint object 2182 represents the viewpoint position of the user 5A in the virtual space 11A. In at least one aspect, this object represents the viewpoint position in the panorama image 13. In FIG. 21, the user 5A is gazing at the cat 2181. In at least one embodiment, the viewpoint object 2182 is tracked, but not displayed to the user.

Referring to FIG. 22, the processor 210A serves as the viewpoint identification module 1426A to identify a line of sight 2288 of the user 5A. Next, the viewpoint identification module 1426A identifies coordinate values 2289 at which the line of sight 2288 and the celestial sphere of the virtual space 11A intersect. The processor 210A arranges the viewpoint object 2182 at the specified coordinate values 2289.

In at least one aspect, the processor 210A transmits to the server 600 the coordinate values 2289 in the XYZ coordinate system identified by the viewpoint identification module 1426A.

Referring again to FIG. 21, the operation object 2183 is a hand object that moves in accordance with the motion of the hand of the user 5A. More specifically, the processor 210A serves as an operation object control module 1429A to generate, based on output of the motion sensor 420A, data for moving the operation object 2183.

The UI object 2184 functions as a user interface for receiving an evaluation by the user 5A of the content included in the panorama image 13. As an example, the UI object 2184 includes an affirmative expression (“Good!” in the example of FIG. 21). In at least one aspect, the processor 210A moves the UI object 2184 in association with the virtual camera 14. That is, the UI object 2184 is moved in the virtual space to remain within a field-of-view image despite movement of the field-of-view image in the virtual space. In this way, the user 5A may always visually recognize the UI object 2184.

The user 5A operates the UI object 2184 when there is content that the user likes in the field-of-view image 2117. As an example, the user 5A brings the operation object 2183 into contact with the UI object 2184 under a state in which his or her line of sight 2288 is directed at the content that he or she likes. In at least one embodiment, contact is determined based on overlapping of coordinates of the operation object 2183 and the UI object 2184. The processor 210A associates and transmits to the server 600 the coordinate values 2289 of the viewpoint object 2182 at the timing when the operation object 2183 and the UI object 2184 were brought into contact with each other and information (first operation information) indicating that those objects are in contact with each other. The server 600 stores the viewpoint position associated with the first operation information in the viewpoint position information 1972 of the storage 630.

In at least one aspect, the processor 210A stores the coordinate values 2289 at the timing when a button (UI) determined in advance of the controller 300A for receiving an interest by the user 5 is pressed as information (second operation information) indicating that the button is pressed to the server 600.

The first and second operation information are signals representing the operation of the user 5A. The operation of the user 5A represented by the first and second operation information indicates an interest by the user 5A. In the following, the first operation information and the second operation information are collectively referred to as “operation information”.

FIG. 23 is a table of a data structure of the viewpoint position information 1972 according to at least one embodiment of this disclosure. The viewpoint position information 1972 stores the user ID, the panorama image ID, the viewpoint position, and the timing in association with each other. The panorama image ID identifies a specific panorama image of the plurality of panorama images 13. The timing represents, when the panorama image 13 is a moving image, the timing at which the operation information is input during playback of the moving image (timing at which viewpoint position is acquired).

The viewpoint position information 1972 in FIG. 23 indicates that the user 5A is gazing at the viewpoint position (X1, Y1, Z1) at the point 5 minutes and 3 seconds after the start of playback of the panorama image 13A.

In the configuration described above, the server 600 is capable of storing in the storage 630 the viewpoint position of the user associated with the operation information. As a result, the distributor of the panorama image 13 can grasp which content included in the panorama image 13 each user has expressed an interest in by referring to the viewpoint positions stored in the storage 630.

Referring again to FIG. 21, the evaluation object 2185 represents the viewpoint position at the timing when the user 5A or another user has input the operation information in the past. The user 5A can grasp, by visually recognizing the evaluation object 2185, which content of the panorama image 13 other users have expressed an interest in.

There is a possibility that the evaluation object 2185 interferes with the user 5A visually recognizing the panorama image 13. Therefore, in at least one embodiment, the evaluation object 2185 is set to be partially translucent (e.g., 50% transmittance).

(Storage Processing Based on User Motion)

In the example described above, the server 600 is configured to store the viewpoint position in the storage based on an operation of the user 5. In such a case, the distributor of the panorama image is unable to sufficiently grasp the interest of the user 5. For example, when the panorama image 13 is a moving image, the user 5 may not be able to input operation information to the computer 200 at a timing when the user is visually recognizing the content that he or she is interested in. There may be cases in which the user 5 thinks inputting the operation information is troublesome. There is now described processing capable of helping to solve such an issue.

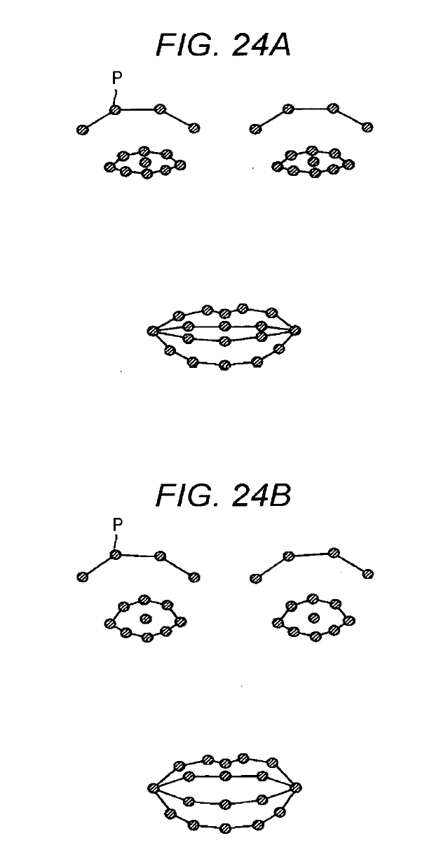

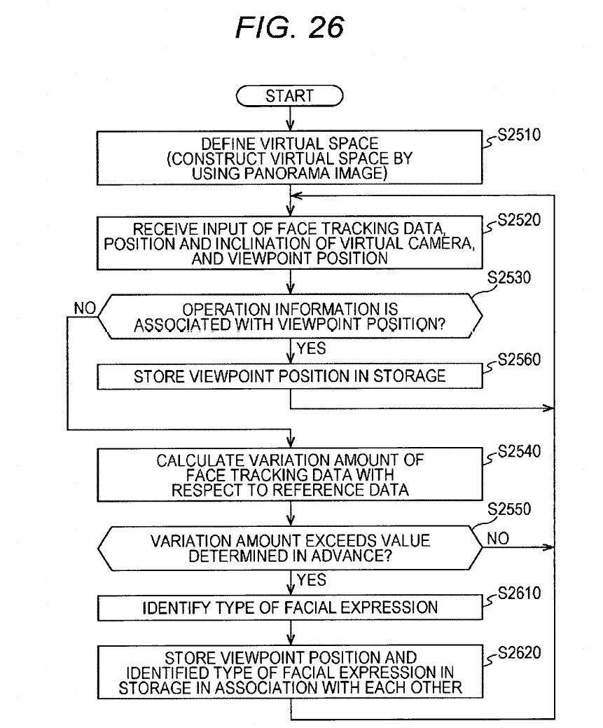

FIG. 24A is a diagram of facial feature points acquired when the user 5A has a neutral facial expression according to at least one embodiment of this disclosure. FIG. 24B is a diagram of facial feature points acquired when the user 5A is surprised according to at least one embodiment of this disclosure. Feature points P in FIG. 24A and FIG. 24B represent the feature points of the face of the user 5A acquired by the motion detection module 1425A.

As described in Step S2008 of FIG. 20, the computer 200A generates face tracking data (reference data) of the user 5A, who has a neutral facial expression. The feature points P in FIG. 24A correspond to this reference data. On the other hand, the feature points P in FIG. 24B correspond to the face tracking data generated in Step S2026. In FIG. 24B, because the user 5A is surprised, the feature points P of the eyes are wider in the height direction of the face, and the feature points P of the eyebrows have moved upward. In other words, the variation amount of the face tracking data with respect to the reference data represents a degree of interest by the user 5A in the content.

Therefore, when the variation amount of the face tracking data with respect to the reference data is more than a variation amount determined in advance, the processor 610 of the server 600 stores the viewpoint position corresponding to the face tracking data in the viewpoint position information 1972. As one example, the viewpoint position corresponding to the face tracking data may be the viewpoint position input at the timing closest to the input timing of the face tracking data.

In at least one aspect, the processor 210A calculates the variation amount of the face tracking data with respect to the reference data for each feature point, and performs the above-mentioned determination based on the sum of those variation amounts. In at least one aspect, the processor 210A calculates the variation amounts only for feature points determined in advance (e.g., feature points corresponding to mouth corners) having a large degree of change due to emotion, and performs the above-mentioned determination based on the sum of those variation amounts.

With the configuration described above, the server 600 may increase the likelihood of the user 5A being able to acquire a viewpoint position at a time when the user 5A expresses an interest in content. The user 5 is not required to perform any operation, and hence the user 5 can concentrate on viewing the panorama image 13.

(Control Structure)

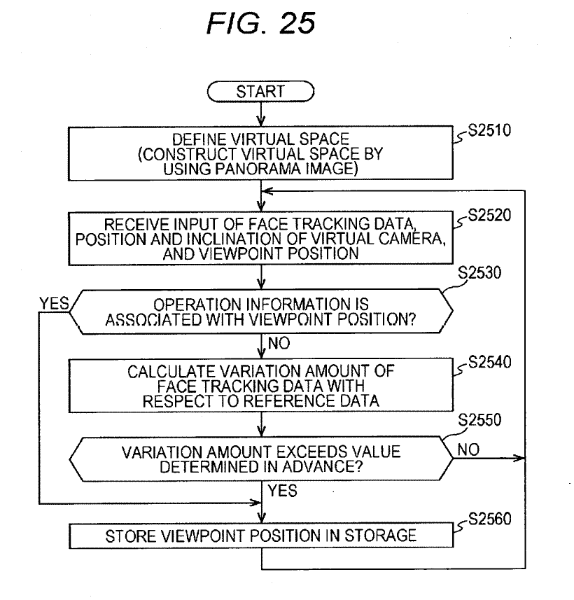

FIG. 25 is a flowchart of processing for storing a viewpoint position in the storage 630 according to at least one embodiment of this disclosure. The processing in FIG. 25 is executed by the processor 610 of the server 600 in at least one embodiment.

In Step S2510, the processor 610 defines the virtual space 11 based on the virtual space designation information 1961. The processor 610 also constructs the virtual space 11 by using, among the plurality of panorama images 13 stored in the panorama image DB 1963, the panorama images 13 designated from the computer 200.

In Step S2520, the processor 610 receives from the computer 200 face tracking data, the position and inclination of the virtual camera 14, the viewpoint position, and a signal representing the operation of the user 5. The face tracking data can be said to be a signal representing the motion of the user 5. The signal representing the operation includes, for example, output of the controller 300. In at least one aspect, the signal representing the operation includes information indicating that the operation object and another object have come into contact with each other.

In Step S2530, the processor 610 determines whether the viewpoint position and the operation information are associated with each other. In response to a determination by the processor 610 that the operation information is associated with the viewpoint position (YES in Step S2530), the processor 610 stores the viewpoint position in the storage 630 (Step S2560). Otherwise (NO in Step S2530), the processor 610 advances the processing to Step S2540.

In Step S2540, the processor 610 calculates the variation amount of the face tracking data with respect to the reference data. More specifically, the processor 610 refers to the reference data DB 1966 to identify the reference data corresponding to the user ID of the transmission source of the face tracking data. The processor 610 compares the identified reference data and the received face tracking data, and calculates the variation amount.

In Step S2550, the processor 610 determines whether the calculated variation amount exceeds a value determined in advance. When the processor 610 determines that the calculated variation amount exceeds the value determined in advance (YES in Step S2550), the processor 610 stores the viewpoint position in the storage 630 (Step S2560). Otherwise (NO in Step S2550), the processor 610 again executes the processing of Step S2520.

As a result of the processing described above, the server 600 according to at least one embodiment of this disclosure can acquire a viewpoint position when the operation or the motion of the user 5 indicates an interest by the user 5.

In at least the example described above, the server 600 is configured to store in the storage 630 the position information on the panorama image 13 in which the user 5 expressed an interest, but in at least one aspect, the server 600 may store information representing the object in which the user 5 expressed an interest in the storage 630. As at least one example, when the user 5 directs his or her line of sight at a predetermined object and the condition for storing the viewpoint position is satisfied, the server 600 stores information (e.g., ID provided for each object) representing the object in the storage 630.

(Storage Processing of Viewpoint Position by Sound)

In at least one embodiment, the server 600 receives input of a sound signal corresponding to an utterance of the user 5 from the computer 200 in Step S2020. The server 600 may also store, when the sound signal satisfies a condition determined in advance, the viewpoint position in the storage 630. In at least one aspect, the server 600 stores the viewpoint position in the storage 630 when the input sound signal exceeds a level determined in advance.

In at least one aspect, the server 600 estimates the emotion of the user 5 based on the input sound signal, and stores the viewpoint position in the storage 630 based on the estimated emotion. For example, the server 600 extracts a character string from the sound signal, and estimates an emotion from the extracted character string. Such processing may be implemented by, for example, “Emotion Analysis API” provided by Metadata Inc. In at least one aspect, the server 600 estimates an emotion from the waveform of the sound signal. Such processing may be implemented by, for example, “ST Emotion SDK” provided by AGI Inc.

Through the processing described above, the server 600 estimates the type of emotion of the user 5 based on the sound signal from among a plurality of types of emotion (e.g., “happiness”, “anger”, “sadness”, “enjoyment”). The server 600 stores the viewpoint position in the storage 630 when the estimated emotion type indicates an interest by the user (e.g., when the type of emotion is “happiness” or “enjoyment”). At this time, the server 600 may also store the estimated emotion type in the storage 630 in association with the viewpoint position.

(Estimation of Emotion)

In at least the example of FIG. 25, the processor 610 is configured to store the viewpoint position in the storage 630 when the variation amount of the face tracking data with respect to the reference data is large. In such a case, the distributor of the panorama image 13 can grasp the content that the user 5 is interested in, but does not know what kind of emotion the user 5 has for the content. In view of the above, the server 600 according to at least one embodiment of this disclosure estimates what kind of emotion the user 5 has for the content.

The processor 610 serves as the emotion determination module 1955 to calculate a feature from the face tracking data having a variation amount with respect to the reference data equal to or more than a threshold. The emotion determination module 1955 identifies the type of the facial expression corresponding to the calculated feature by using facial expression discriminators 1973 to 1976.

As an example, the emotion determination module 1955 uses the facial expression discriminators 1973 to 1976 in accordance with a plurality of support vector machines (SVMs) to identify the type of the facial expression (happiness, anger, surprise, or sadness) from a feature derived by a convolutional neural network (CNN). The method for identifying the type of the facial expression is not limited to this method, and other machine learning techniques may be applied.

In at least one aspect, the emotion determination module 1955 may identify the type of the facial expression based on an arrangement pattern of the face tracking data. In at least one aspect, the emotion determination module 1955 may receive input of the facial image of the user 5 (image photographed by first camera 150 and second camera 160), and identify the type of the facial expression based on the facial image.

FIG. 26 is a flowchart of processing for storing the viewpoint position and the type of emotion in association with each other according to at least one embodiment of this disclosure. Of the processing in FIG. 26, processing that is similar to that described above is denoted with like reference numerals, and a description thereof is omitted here.

In Step S2610, the processor 610 serves as the emotion determination module 1955 to identify the type of the facial expression based on face tracking data having a variation amount with respect to the reference data exceeding a value determined in advance.

In Step S2620, the processor 610 stores the viewpoint position and the identified type of the facial expression in association with each other in the storage 630 (viewpoint position information 1972).

With the processing described above, the server 600 according to at least one embodiment of this disclosure can store in the storage 630 the position information (viewpoint position) on the content that the user 5 is interested in and the emotion (facial expression) of the user 5 with regard to that content in association with each other. In this way, the distributor of the panorama image 13 can obtain a more detailed evaluation by the user 5 on the panorama image 13.

(Visualization of Viewpoint)

In at least the example described above, the processor 610 is configured to store in the storage 630 the viewpoint position in which the user 5 expressed an interest. In this case, the distributor of the panorama image 13 checks a correspondence relationship between the viewpoint position (coordinate values) and the panorama image 13. Therefore, the processor 610 according to at least one embodiment of this disclosure serves as the map generation module 1956 to create a graph based on the panorama image 13 and the viewpoint position information 1972. This graph visualizes the viewpoint position (position in which the user 5 expresses interest) in the panorama image 13.

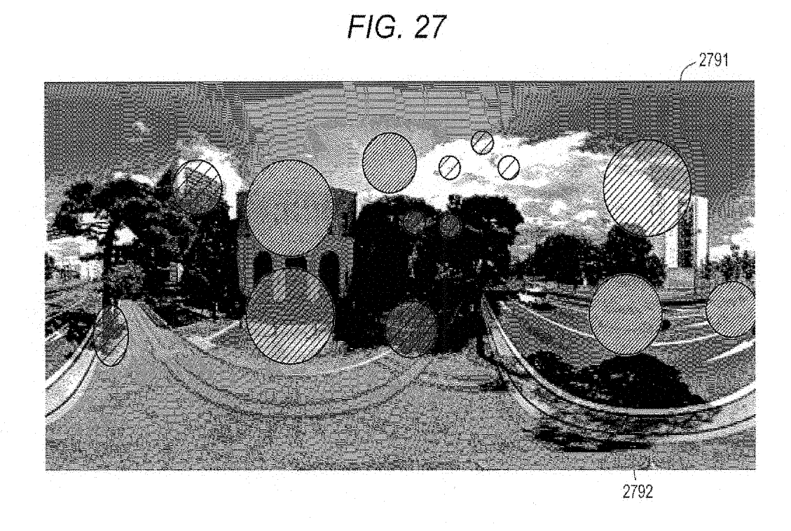

FIG. 27 is a diagram of a heat map 2791 based on the viewpoint position information 1972 according to at least one embodiment of this disclosure. As at least one example, the processor 610 generates the heat map 2791 by expressing regions in which the viewpoint position on the panorama image 13 is dense in red and regions in which the viewpoint position is sparse in blue. In at least the example of FIG. 27, a region 2792 is a region in which the viewpoint position is dense, and is hatched in red.

Through viewing the heat map 2791, the distributor of the panorama image 13 may easily understand the content in the panorama image 13 the user 5 has expressed an interest in.

In at least one aspect, the processor 610 stores the viewpoint position in the viewpoint position information 1972 in association with whether the user of the transmission source of the viewpoint position is communicating to/from another user. For example, in at least the example in FIG. 22, when the processor 610 receives the coordinate values 2289 representing the viewpoint position from the computer 200A, the processor 610 determines that the user 5A is communicating to/from the user 5B, and stores that fact in association with the viewpoint position in the viewpoint position information 1972.

The processor 610 according to at least one embodiment of this disclosure may generate a heat map based on the viewpoint position in the case in which the user 5A is communicating to/from another user and a heat map based on the viewpoint position in the case in which the user 5A is not communicating to/from another user. In such a case, the distributor of panorama image 13 may easily understand the difference between the content for which interest is expressed when the user is viewing the panorama image 13 alone and the content for which interest is expressed when a plurality of users are viewing the panorama image 13.

[Identification of Content for which User Expressed Interest]

In the above-mentioned example, the processor 610 stores the viewpoint position in the storage 630, but does not identify the content displayed in the viewpoint position. Therefore, in order to understand the content in which the user has expressed an interest, the distributor of the panorama image 13 investigates the correspondence relationship between the viewpoint position (coordinate values) and the panorama image 13. Thus, the processor 610 according to at least one embodiment of this disclosure identifies the content displayed in the viewpoint position.

Referring to FIG. 21, the viewpoint object 2182 of user 5A is superimposed on the cat 2181. In at least one aspect, the computer 200A transmits to the server 600 the viewpoint position at which the viewpoint object 2182 is arranged.

The processor 610 of the server 600 serves as the cutout module 1957 to cut out a peripheral image 2186 around the viewpoint position received from the panorama image 13 developed in the virtual space 11A. In at least one aspect, the cutout module 1957 cuts out a rectangular region determined in advance and centered around the viewpoint position as the peripheral image 2186. In at least one aspect, the cutout module 1957 cuts out, as the peripheral image 2186, a bounding box in which the content of the viewpoint position is present by using a known object detection method. In at least one embodiment, the shape of the bounding box is different from a rectangle. For example, the cutout module 1957 sets a minimum region (e.g., 3×3 pixels) centered around the viewpoint position by using a selective search method, and cuts out the peripheral image 2186 (bounding box) based on the range occupied by a region similar to that region.

Next, the processor 610 serves as the target identification module 1958 to identify the content included in the peripheral image 2186, that is, the target at which the user 5A is directing his or her line of sight. The target identification module 1958 identifies the target (content) by using the object discriminators 1477, 1478, 1479 . . . in a similar manner as the emotion determination module 1955. Therefore, a description of this identification processing is not repeated here. The processor 610 may store a line-of-sight position and the identified target in the viewpoint position information 1972 in association with each other.

Next, the processor 610 identifies, based on the identified target (content for which user 5A expressed interest), an advertisement that the user 5A would probably express interest in from the advertisement DB 1965, and distributes the identified advertisement to the computer 200A.

(Control Structure)

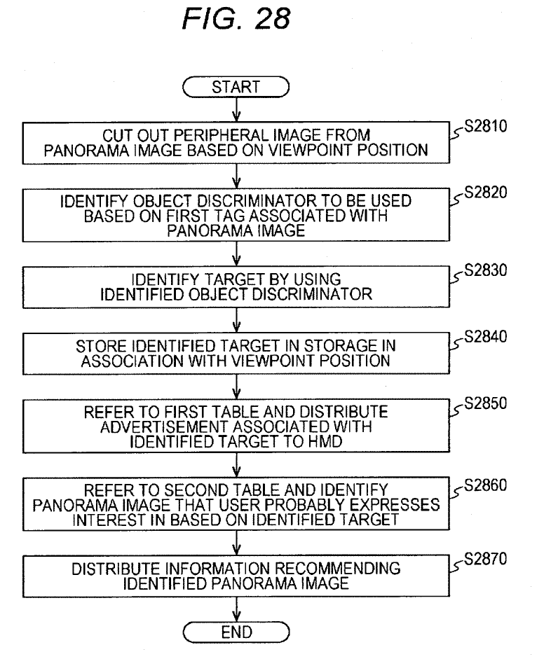

FIG. 28 is a flowchart of a series of processing steps until identification of the target at which the user 5 is directing his or her line of sight to distribute an advertisement according to at least one embodiment of this disclosure. The processing in FIG. 28 is implemented by the processor 610 of the server 600 according to at least one embodiment.

In Step S2810, the processor 610 serves as the cutout module 1957 to cut out a peripheral image from the panorama image 13 based on the viewpoint position received from the computer 200.

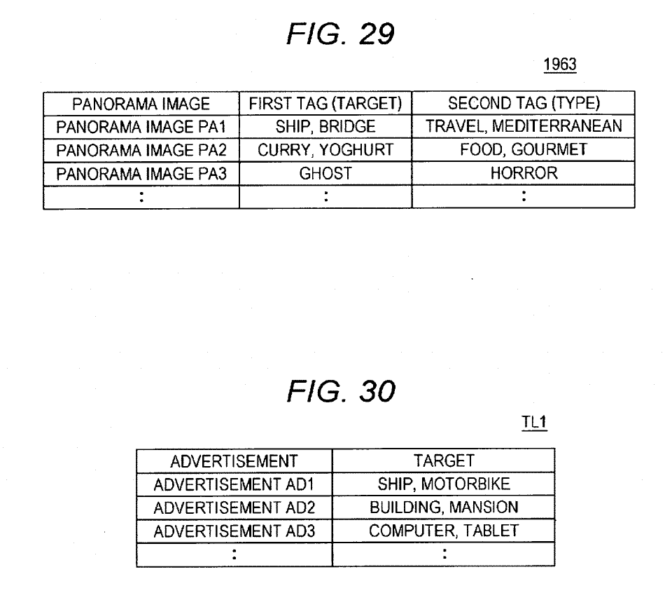

In Step S2820, the processor 610 serves as the target identification module 1958 to identify the object discriminator to be used based on a first tag associated with panorama image 13. The object discriminator outputs a likelihood representing a probability of an object to be identified being a target object. This processing is described in more detail with reference to FIG. 29.

FIG. 29 is a table of the data structure of the panorama image DB 1963 according to at least one embodiment of this disclosure. The panorama image DB 1963 according to at least one embodiment of this disclosure stores the panorama image 13, the first tag, and a second tag in association with each other.

The first tag identifies the target (content) included in the panorama image 13. The second tag identifies the type of the panorama image 13. As at least one example, the first and second tags may be set by the distributor of the panorama image 13. In at least one aspect, the first and second tags may be set by a viewer (user) of the panorama image 13.

In at least the example in FIG. 29, “ship” and “bridge” are associated as the first tag, and “travel” and “Mediterranean” are associated as the second tag in a panorama image PA1. The target identification module 1958 identifies, based on the first tag associated with the panorama image PA1, each object discriminator corresponding to “ship” and “bridge” from the object discriminator DB 1968.

Referring again to FIG. 28, in Step S2830, the processor 610 serves as the target identification module 1958 to identify the target (content) included in the peripheral image by using the identified object discriminator. Specifically, the processor 610 calculates the feature of the peripheral image, and inputs the calculated feature to the identified object discriminator. The object discriminator outputs, based on the input feature, a likelihood representing how likely it is that the target (content) included in the peripheral image is the target object to be identified. The processor 610 acquires the likelihood output from the object discriminator. The processor 610 identifies a target (content) corresponding to the calculated feature in accordance with this likelihood.

In Step S2840, the processor 610 stores the identified target in the storage 630 (viewpoint position information 1972) in association with the viewpoint position.

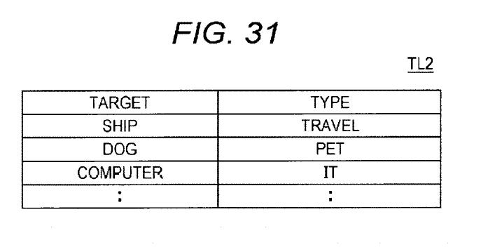

In Step S2850, the processor 610 refers to the first table TL1 and distributes the advertisement associated with the identified target to (the HMD 120 connected to) the computer 200 of the transmission source of the viewpoint position. This processing is described more specifically with reference to FIG. 30.

FIG. 30 is a table of the data structure of the first table TL1 according to at least one embodiment of this disclosure. The first table TL1 stores advertisements and targets (content) in association with each other. In at least one aspect, the processor 610 identifies that the target at which the user 5 is gazing is a “ship”. In such a case, the processor 610 refers to the first table TL1, and distributes an advertisement AD1 associated with the “ship” to the computer 200 of the transmission source of the viewpoint position. The computer 200 outputs the received advertisement AD1 to the HMD 120. As a result, the user 5 visually recognizes the advertisement AD1.

Referring again to FIG. 28, in Step S2860, the processor 610 refers to the second table TL2, and identifies the panorama image 13 that the user 5 probably expresses interest in based on the identified target. This processing is described in more detail with reference to FIG. 31.

FIG. 31 is a table of the data structure of the second table TL2. The second table TL2 includes targets (content) and types of the panorama image 13. In at least one aspect, the processor 610 identifies that the target at which the user 5 is gazing is a “ship”. In such a case, the processor 610 refers to the second table TL2, and identifies that the type corresponding to the “ship” is “travel”. The processor 610 further refers to the panorama image DB 1963, and identifies the panorama image 13 associated with “travel” as the second tag.

Referring again to FIG. 28, in Step S2870, the processor 610 distributes information recommending the identified panorama image 13 to (the HMD 120 connected to) the computer 200 of the transmission source of the viewpoint position. This information may include, for example, an image of a portion of the identified panorama image 13 and a panorama image ID.

The computer 200 recommends the identified panorama image 13 to the user 5 based on the information received from the server 600.

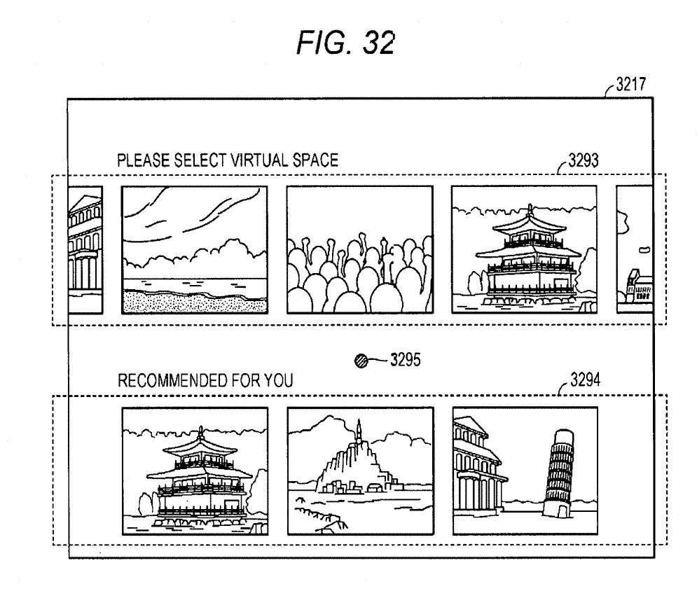

FIG. 32 is a diagram of the processing for recommending the panorama image 13 to the user 5 according to at least one embodiment of this disclosure. In at least one aspect, the monitor 130 of the HMD 120 displays a field-of-view image 3217 for the user 5 to select the panorama image 13.

The field-of-view image 3217 includes a selection region 3293, a recommendation region 3294, and a viewpoint object 3295. The selection region 3293 includes a portion of each of the plurality of panorama images 13 stored in the panorama image DB 1963. The recommended region 3294 includes a portion of the panorama image 13 identified based on the above-mentioned information received from the server 600. Specifically, the user 5 is highly likely to express an interest in the panorama image 13 included in the recommended region 3294. Therefore, the user 5 may easily search for the panorama image 13 he or she is interested in from the recommended region 3294.

In at least one aspect, the user 5 operates the viewpoint object 3295 to select the panorama image 13. As an example, the user 5 superimposes the viewpoint object 3295 for a time (e.g., three seconds) determined in advance on the portion of the panorama image 13 that he or she is interested in. The computer 200 transmits information (e.g., panorama image ID) representing the panorama image 13 selected by the user 5 to the server 600. The server 600 transmits the panorama image 13 selected by the user 5 to the computer 200. The computer 200 constructs the virtual space 11 by using the received panorama image 13. As a result, the user 5 is able to visually recognize the virtual space 11 formed from the designated panorama image 13.

With the configuration described above, the server 600 according to at least one embodiment of this disclosure identifies the target (content) for which the user 5 expressed an interest. At that time, the server 600 is capable of narrowing down the object discriminator to be used based on the first tag associated with the panorama image 13, and hence the load required for identifying the target can be greatly reduced. In addition, through setting the first tag, the distributor of the panorama image 13 can narrow down in advance the content to be analyzed among the plurality of content included in the panorama image 13.

The server 600 can efficiently distribute, based on the identified target, the panorama image 13 and an advertisement having a high likelihood of the user 5 expressing an interest in the advertisement.

[Filtering Processing]

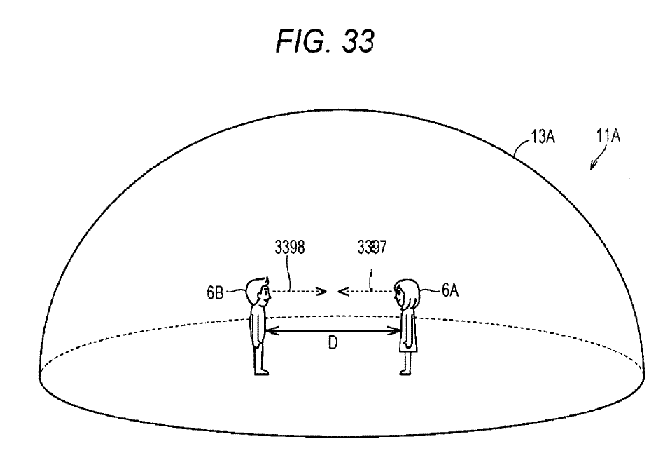

FIG. 33 is a diagram of processing to be executed when the viewpoint position is not stored in the viewpoint position information 1972 according to at least one embodiment of this disclosure. Referring to FIG. 33, the panorama image 13A is developed in the virtual space 11A. In the virtual space 11A, an avatar object 6A corresponding to the user 5A and an avatar object 6B corresponding to the user 5B are arranged.

In at least the example described above, the processor 610 is configured to store the viewpoint position of the user 5A in the storage 630 based on the motion (facial expression or sound) of the user 5A. However, the user 5A is able to communicate to/from the user 5B in the virtual space 11A. Therefore, there is a possibility that the motion of the user 5A is not attributable to the panorama image 13A, and that the motion of the user 5A is attributable to communication to/from the user 5B. In such a case, the distributor of the panorama image 13 is has difficulty in correctly grasping the interest of the user 5A in the panorama image 13. In view of the above, in response to a determination that communication is being performed between the users, the processor 610 according to the server 600 of at least one embodiment of this disclosure serves as the filter module 1959 to stop the processing of storing the viewpoint position based on the motion of the user. The processing by the filter module 1959 is now described with reference to FIG. 33.

In at least one aspect, the filter module 1959 determines that the users 5A and 5B are communicating when those users are facing each other in the virtual space.

The processor 610 receives from the computer 200A line-of-sight information representing a line of sight 3397 of the user 5A. The processor 610 receives from the computer 200B line-of-sight information representing a line of sight 3398 of the user 5B. For example, when the angle formed by the line of sight 3397 and the line of sight 3398 is approximately 180 degrees (e.g., 170 to 190 degrees), the filter module 1959 determines that the users 5A and 5B are facing each other in the virtual space.

In this case, the processor 610 does not store the viewpoint position in the storage 630 even when the motion (facial expression or sound) of the user 5 satisfies the condition determined in advance.

In at least one aspect, when the distance in the virtual space between the standpoint of the user 5A and the standpoint of 5B is narrow, the filter module 1959 determines that those users are communicating.

The processor 610 receives position information (standpoint information of the user 5A in the virtual space 11A) on the virtual camera 14A from the computer 200A. The processor 610 receives position information on the virtual camera 14B from the computer 200B. The filter module 1959 calculates a distance D between the standpoint of the user 5A and the standpoint of the user 5B based on the received position information. When the distance D is less than a distance determined in advance, the filter module 1959 determines that the distance between the two users in the virtual space is small.

In at least one aspect, the filter module 1959 determines that the users 5A and 190B are communicating when those users are talking.

The processor 610 receives from the computer 200A a first sound signal corresponding to the utterance of the user 5A. The processor 610 receives from the computer 200B a second sound signal corresponding to the utterance of the user 5B. The filter module 1959 determines that the users 5A and 5B are talking when the first and second sound signals are equal to or more than a level determined in advance.

(Control Structure)

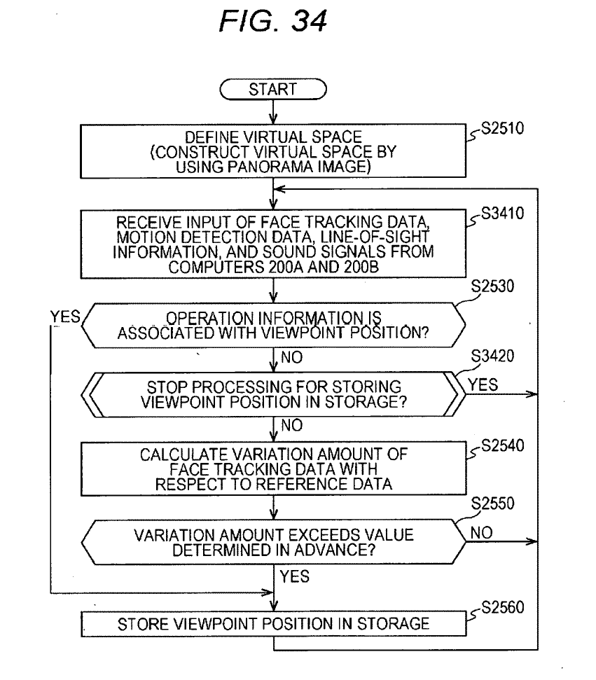

FIG. 34 is a flowchart of processing for stopping the processing for storing the viewpoint position in the viewpoint position information 1972 according to at least one embodiment of this disclosure. Of the processing illustrated in FIG. 34, processing that is similar to that described above is denoted with like reference numerals, and a description thereof is omitted here.

In Step S3410, the processor 610 receives face tracking data, the position and inclination of the virtual camera 14, the viewpoint position, the line-of-sight direction, and the sound signals from the computers 200A and 200B. The position of the virtual camera 14 represents the standpoint of the user 5 in the virtual space 11. The line-of-sight direction is the direction of the line of sight of the user 5 in the virtual space 11, which is identified by the viewpoint identification module 1426.

When operation information is not associated with the viewpoint position (NO in Step S2530), the processor 610 advances the processing to Step S3420.

In Step S3420, the processor 610 serves as the filter module 1959 to determine whether to stop the processing for storing the viewpoint position in the storage 630. In response to a determination that the storage processing is to be stopped (YES in Step S3420), the processor 610 again executes the processing of Step S2910. On the other hand, in response to a determination that the storage processing is not to be stopped (NO in Step S3420), the processor 610 advances the processing to Step S2540.

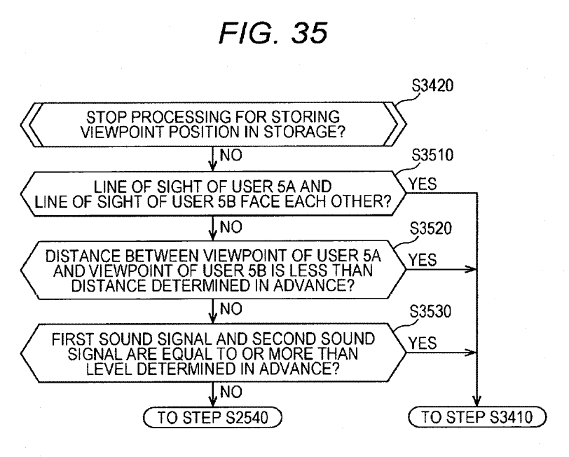

FIG. 35 is a flowchart of the processing of Step S3420 according to at least one embodiment of this disclosure. In Step S3510, the processor 610 determines whether the line of sight of the user 5A and the line of sight of the user 5B face each other. In response to a determination that those lines of sight face each other (YES in Step S3510), the processor 610 again executes the processing of Step S2910.

In Step S3520, the processor 610 determines whether the distance D between the standpoint of the user 5A and the standpoint of the user 5B is less than a distance determined in advance. In response to a determination that the distance D is less than the distance determined in advance (YES in Step S3520), the processor 610 again executes the processing of Step S2910.

In Step S3530, the processor 610 determines whether the first sound signal corresponding to the user 5A and the second sound signal corresponding to the user 5B are equal to or more than a level determined in advance. In response to a determination that the first and second sound signals are equal to or more than the level determined in advance (YES in Step S3530), the processor 610 again executes the processing of Step S2910.

In response to a determination that the condition in each of Step S3510 to Step S3530 is not satisfied, the processing proceeds to Step S2540.

With the processing described above, in response to a determination that the users are communicating with each other, the server 600 can stop the processing for storing the viewpoint position based on the motion of the user 5. As a result, the server 600 may more correctly acquire the interest of the user 5 in the panorama image 13.

In the example described above, the processor 610 is configured to stop the processing for storing the viewpoint position when any one of the conditions of Step S3510 to Step S3530 is satisfied. In at least one aspect, the processor 610 may be configured to stop the processing for storing the viewpoint position when a plurality of the conditions are satisfied among the conditions of Step S3510 to Step S3530.

[Configurations]

The technical features of at least one embodiment are summarized as follows.

(Configuration 1) According to at least one embodiment of this disclosure, there is provided a program to be executed by a server 600 operable to communicate to/from an HMD 120. The program causes a computer to execute defining a virtual space 11 (Step S2510). The computer is further configured to execute acquiring a viewpoint position of a user 5 of the HMD 120 in the virtual space 11 based on output of the HMD 120 (Step S2520). The computer is further configured to execute receiving a signal representing an operation or a motion of the user 5 (Step S2520); and storing, when the operation or the motion of the user 5 represented by the signal indicates an interest of the user 5, a viewpoint position in a storage 630 (viewpoint position information 1972) (Step S2560).

In at least one aspect, the computer 200 outputs to the server 600 the viewpoint position of the user 5 in the virtual space 11 calculated from output of an eye gaze sensor 140 arranged in the HMD 120. As a result, the server 600 acquires the viewpoint position of the user 5. In at least one aspect, the computer 200 transmits to the server 600 line-of-sight information representing a line of sight of the user 5 in the virtual space 11 calculated from output of the eye gaze sensor 140 arranged in the HMD 120. The computer 200 may acquire the viewpoint position of the user 5 in the virtual space 11 based on the received line-of-sight information.

(Configuration 2) In Configuration 1, the defining of the virtual space 11 includes constructing the virtual space 11 by using a panorama moving image. The storing of the viewpoint position in the storage 630 includes storing the viewpoint position and the timing at which the viewpoint position is acquired during playback of the moving image in the storage 630 in association with each other (FIG. 23).

(Configuration 3) In Configuration 1 or 2, the operation of the user 5 indicating an interest of the user 5 includes an operation on a user interface for receiving the interest of the user 5. The user interface may be, for example, a specific button arranged in a controller 300. As at least one example, the user interface may be a UI object 2184 located in the virtual space 11.

(Configuration 4) In any one of Configurations 1 to 3, the signal representing a motion of the user 5 includes face tracking data representing a facial expression of the user 5.

(Configuration 5) The program according to Configuration 4 further includes receiving input of reference data to be used for comparison with the face tracking data (Step S2012). The face tracking data indicating an interest of the user 5 includes a variation amount of the face tracking data with respect to the reference data exceeding a variation amount determined in advance (Step S2550).

(Configuration 6) In Configuration 4 or 5, the storing of the viewpoint position in the storage 630 includes identifying, when the face tracking data indicates an interest of the user 5, a type of the facial expression corresponding to the face tracking data from among a plurality of types of facial expression (Step S2610). The storing of the viewpoint position further includes storing the identified type of the facial expression and the viewpoint position in the storage 630 in association with each other (Step S2620).

(Configuration 7) In any one of Configurations 1 to 6, the signal representing a motion of the user 5 includes a sound signal corresponding to an utterance of the user 5.

(Configuration 8) The program according to Configuration 7 further includes estimating a type of emotion of the user 5 corresponding to the sound signal from among a plurality of types of emotion. The storing of the viewpoint position in the storage 630 includes, when the estimated type of emotion of the user 5 indicates the interest of the user 5, storing the estimated type of emotion of the user 5 and the viewpoint position in the storage 630 in association with each other.

(Configuration 9) In any one of Configurations 1 to 8, the storing of the viewpoint position in the storage 630 includes identifying, when the signal indicates the interest of the user 5, a target at which the line of sight of the user 5 is directed in the virtual space 11 (Step S2830). The storing of the viewpoint position further includes storing the target in the storage 630 in association with the viewpoint position (Step S2840).

(Configuration 10) In Configuration 9, an object discriminator DB 1447 stored in the storage 630 stores object discriminators 1477, 1472, 1473, . . . for each type of target. The defining of the virtual space 11 includes constructing the virtual space 11 by using a panorama image 13. The identifying of the target includes cutting out a peripheral image of the viewpoint position from the panorama image (Step S2810), calculating a feature from the peripheral image, and identifying a target corresponding to the calculated feature by using the object discriminators 1477, 1478, 1479, . . . stored for each type of target (Step S2820).

(Configuration 11) In Configuration 10, the panorama image 13 includes first tag information indicating the target included in the panorama image 13 (FIG. 29). The identifying of the target includes identifying, among the plurality of object discriminators 1477, 1478, 1479, . . . stored in the storage device, the target corresponding to the feature by using the object discriminator of the target indicated by the first tag information (Step S2830).

(Configuration 12) The program according to any one of Configurations 9 to 11 further includes distributing to the HMD 120 an advertisement relating to the identified target (Step S2850).

(Configuration 13) In any one of Configurations 10 to 12, the storage 630 includes a panorama image DB 1963 for storing a plurality of panorama images 13. The program according to any one of Configurations 10 to 12 further includes identifying a panorama image relating to a target identified from among the plurality of panorama images 13 (Step S2860). The computer is further configured to execute distributing information recommending the identified panorama image to the HMD 120 (Step S2870).

(Configuration 14) In Configuration 13, the panorama image 13 includes second tag information indicating the type of the panorama image 13 (FIG. 29). The storage 630 includes the panorama image DB 1963 storing a correspondence relationship between targets and types of panorama images. The identifying of the panorama image 13 includes referring to the panorama image DB 1963 to identify the panorama image 13 including second tag information of the type corresponding to the identified target.

(Configuration 15) In any one of Configurations 1 to 14, the defining of the virtual space 11 includes constructing the virtual space 11 by using the panorama image 13. The program according to any one of Configurations 1 to 14 further includes generating a graph from the panorama image 13 and the viewpoint position stored in the storage 630. The heat map 2791 is an example of this graph.

(Configuration 16) The program according to any one of Configurations 1 to 15 further includes receiving input of a first line-of-sight direction of a user 5A in a virtual space 11A and a second line-of-sight direction of a user 5B, who is using another HMD 120B different from an HMD 120A, in a virtual space 11B (Step S3410). The storing of the viewpoint position in the storage 630 includes stopping storing the viewpoint position in the storage 630 when the first line-of-sight direction and the second line-of-sight direction face each other (Step S3510).

(Configuration 17) The program according to any one of Configurations 1 to 16 further includes receiving input of a first standpoint of the user 5 in the virtual space 11A and a second standpoint of the user 5B, who is using another HMD 120B different from the HMD 120A, in the virtual space 11B (YES in Step S3510). The storing the viewpoint position in the storage 630 includes stopping storing the viewpoint position in the storage 630 when a distance D between the first standpoint and the second standpoint is less than a predetermined distance (YES in Step S3520).

(Configuration 18) The program according to any one of Configurations 1 to 17 further includes receiving input of a first sound signal of the user 5 and a second sound signal of the user 5B, who is using another HMD 120B different from the HMD 120A (Step S3410). The storing of the viewpoint position in the storage 630 includes stopping storing the viewpoint position in the storage 630 when the first sound signal and the second sound signal are equal to or more than a level determined in advance (YES in Step S3530).

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

One of ordinary skill in the art would understand that the embodiments disclosed herein are merely examples in all aspects and in no way intended to limit this disclosure. The scope of this disclosure is defined by the appended claims and not by the above description, and this disclosure encompasses all modifications made within the scope and spirit equivalent to those of the appended claims.

1-16. (canceled)

17. A method, comprising:
defining a virtual space,
wherein the virtual space comprises a first virtual viewpoint associated with a first viewpoint of a first user, and
wherein the first user is associated with a first head-mounted device (HMD);
detecting a first line of sight of the first user;
identifying a first virtual line of sight from the first virtual viewpoint in the virtual space based on the detected first line of sight;
identifying an eye gaze position of the first virtual line of sight based on the first virtual line of sight;
defining a predetermined condition relating to an interest of the first user;
detecting an operation or a motion of the first user;
determining whether the operation or the motion satisfies the predetermined condition; and
storing the eye gaze position in a storage device in response to the operation or motion satisfying the predetermined condition, wherein the eye gaze position comprises the eye gaze position identified when the operation or motion satisfies the predetermined condition.

18. The method according to claim 17,
wherein the virtual space comprises a background constructed from a moving image,
wherein the method further comprises determining whether the moving image is being played back, and
wherein the storing of the eye gaze position in the storage device comprises storing in the storage device the eye gaze position and playback time information indicating a playback time of the moving image from a start time in accordance with the operation or the motion satisfying the predetermined condition and the moving image being played back, and the playback time information indicates a point in time at which the moving image is being played back when the operation or the motion satisfies the predetermined condition.

19. The method according to claim 17, wherein the operation or the motion satisfying the predetermined condition comprises input of an indication of interest by the first user.

20. The method according to claim 17,
wherein the detecting of the operation or the motion of the first user comprises detecting a facial expression of the first user,
wherein the method further comprises:
defining a reference facial expression of the first user; and
defining a threshold, and
wherein the operation or the motion satisfying the predetermined condition comprises a difference between the detected facial expression and the reference facial expression exceeding the threshold.

21. The method according to claim 20,
wherein the method further comprises identifying a type of the detected facial expression, and
wherein the storing of the eye gaze position in the storage device comprises storing the eye gaze position and the type of the detected facial expression in the storage device in response to the difference between the detected facial expression and the reference facial expression exceeding the threshold.

22. The method according to claim 17,
wherein the detecting of the operation or the motion of the first user comprises detecting an utterance of the first user,
wherein the method further comprises:
estimating an emotion of the first user corresponding to the detected utterance; and
defining a predetermined emotion,
wherein the operation or the motion satisfying the predetermined condition comprises the estimated emotion being equivalent to the predetermined emotion, and
wherein the storing of the eye gaze position in the storage device comprises storing the eye gaze position and the estimated emotion in the storage device in response to the operation or the motion satisfying the predetermined condition.

23. The method according to claim 17,
wherein the method further comprises identifying a target object present at the eye gaze position, and
wherein the storing of the eye gaze position in the storage device comprises storing the eye gaze position and the target object in the storage device in accordance with the operation or the motion satisfying the predetermined condition.

24. The method according to claim 23,
wherein the virtual space has a background comprising an image,
wherein the identifying of the eye gaze position comprises identifying that the eye gaze position is present on the image, and
wherein the identifying of the target object comprises:
acquiring a plurality of object classifiers,
wherein each of the plurality of object classifiers is configured to identify a different type of target object, and
wherein each of the plurality of object classifiers is configured to output a likelihood representing a probability of an object to be identified being a target object;
cutting out a peripheral image of the eye gaze position from the image;
calculating a feature of the peripheral image;
inputting the feature to the plurality of object classifiers;
acquiring from each of the plurality of object classifiers the likelihood to be output in response to the input of the feature; and
identifying a target object corresponding to the feature based on the likelihood output acquired from each of the plurality of object classifiers.

25. The method according to claim 24,
wherein the image includes first tag information indicating a target object included in the image,
wherein the identifying of the target object further comprises:
acquiring the first tag information from the image; and,
acquiring a first object classifier of the plurality of object classifiers that is to identify the target object indicated by the first tag information,
wherein the inputting of the feature comprises inputting the feature to the first object classifier,
wherein the acquiring of the likelihood comprises acquiring, from the first object classifier, the likelihood output in response to the input of the feature, and
wherein the identifying of the target object corresponding to the feature comprises identifying a target object corresponding to the feature based on the likelihood output from the first object classifier.

26. The method according to claim 23,
wherein an advertisement and a target object are stored in the storage device in accordance with each other, and
wherein the method further comprises:
identifying an advertisement relating to the identified target object from the stored content; and
distributing the identified advertisement to the first head-mounted device.

27. The method according to claim 24,
wherein the virtual space comprises a background comprises one of a plurality of panoramic images,
wherein the plurality of panorama images is stored in the storage device, and
wherein the method comprises:
identifying a panorama image of the plurality of panoramic images relating to the identified target object by using as an input a result of the target object being identified;
generating information recommending the identified panorama image; and
distributing the generated information to the first head-mounted device.

28. The method according to claim 27,
wherein the panorama image includes second tag information indicating a type of the panorama image,
wherein the storage device is configured to store a table for storing a correspondence relationship between the target object and the type of the panorama image, and
wherein the identifying of the panorama image comprises referring to the table by using as an input a result of the target object being identified and identifying a panorama image including second tag information of a type corresponding to the identified target object.

29. The method according to claim 17,
wherein the virtual space comprises a background comprising a panorama image, and
wherein the method comprises:
storing the panorama image and the eye gaze position in the storage device; and
generating a graph in which the eye gaze position is superimposed on the panorama image.

30. The method according to claim 17,
wherein the virtual space comprises a second virtual viewpoint associated with a second viewpoint of a second user, and the second user is associated with a second head-mounted device,
wherein the method further comprises:
detecting a second line of sight of the second user;
identifying a second virtual line of sight from the second virtual viewpoint in the virtual space in response to the detected second line of sight; and
determining whether an angle between a direction of the first virtual line of sight in the virtual space and a direction of the second virtual line of sight is substantially 180-degrees, and
wherein the storing of the eye gaze position in the storage device comprises avoiding storing, in response to a determination that the angle between the direction of the first virtual line of sight and the direction of the second virtual line of sight is substantially 180-degrees, the eye gaze position in the storage device.

31. The method according to claim 17,
wherein the virtual space comprises a second virtual viewpoint associated with a second viewpoint of a second user, and the second user is associated with a second head-mounted device,
wherein the method further comprises:
detecting a second line of sight of the second user; and
identifying a second virtual line of sight from the second virtual viewpoint in the virtual space in accordance with the second line of sight, and
wherein the storing of the eye gaze position in the storage device comprises avoiding storing, in response to a determination that a distance between the first virtual viewpoint and the second viewpoint is less than a threshold, the eye gaze position in the storage device.

32. The program according to claim 17,
wherein the virtual space comprises a second virtual viewpoint associated with a second viewpoint of a second user, and the second user is associated with a second head-mounted device,
wherein the method further comprises:
receiving input of the first sound signal of the first user and the second sound signal of the second user; and
determining whether a level of the first sound signal and a level of the second sound signal are equal to or more than a threshold, and
the storing of the eye gaze position in the storage device comprises avoiding storing, in response to a determination that the level of the first sound signal and the level of the second sound signal are equal to or more than the threshold, the eye gaze position in the storage device.
